(19) United States
(12) Patent Application Publication
(10) Pub. No.: US 2024/0278055 A1
(43) Pub. Date: Aug. 22, 2024

(54) FOAM STABILIZING COMPOSITION INCLUDING A SILOXANE CATIONIC SURFACTANT AND COLLOIDAL SILICA

(71) Applicant: Dow Silicones Corporation, Midland, MI (US)

(72) Inventors: Anirudha Banerjee, Midland, MI (US); Nanguo Liu, Midland, MI (US); Zachary Wenzlick, Midland, MI (US); Yihan Liu, Midland, MI (US)

(21) Appl. No.: 18/553,850

(22) PCT Filed: Jun. 21, 2022
(86) PCT No.: PCT/US2022/073047

§ 371 Date: Oct. 4, 2023

Related U.S. Application Data
(60) Provisional application No. 63/218,940, filed on Jul. 7, 2021.

(51) Int. Cl. A62D 1/02; A62D 1/00; C01B 33/14; C08G 77/04; C08G 77/26

(52) U.S. Cl. CPC A62D 1/0071; A62D 1/0014; C01B 33/14; C08G 77/045; C08G 77/26; C01P 2004/64

(57) ABSTRACT

A foam stabilizing composition includes a) colloidal silica and b) a siloxane cationic surfactant. The siloxane cationic surfactant includes a cationic moiety having the formula Z¹-D¹-N(Y)ₐ(R)₂₋ₐ, where Z¹ is a siloxane moiety, D¹ is a divalent linking group, R is H or an unsubstituted hydrocarbyl group having from 1 to 4 carbon atoms, subscript a is 1 or 2, and each Y has formula -D-NR¹₃+, where D is a divalent linking group and each R¹ is independently an unsubstituted hydrocarbyl group having from 1 to 4 carbon atoms. A firefighting includes the foam stabilizing composition and water. Methods of making and using the same are also provided.

### CROSS REFERENCE TO RELATED APPLICATIONS

This application claims the benefit of U.S. Provisional Patent Application Ser. No. 63/218,940 filed on 7 Jul. 2021 under 35 U.S.C. § 119 (e). U.S. Provisional Patent Application Ser. No. 63/218,940 is hereby incorporated by reference.

### FIELD

A foam stabilizing composition and methods for its preparation are provided. The foam stabilizing composition is suitable for use in forming an aqueous foam that can be used for firefighting applications.

### INTRODUCTION

Aqueous foams are highly effective for extinguishing class B (flammable liquid) fires, and have been used for this purpose for 40 to 50 years. The active ingredient in most aqueous foam used for firefighting is a perfluoroalkyl surfactant. An aqueous foam made with the perfluoroalkyl surfactant can smother a fire with a knockdown time (i.e., the time required to completely extinguish the fire) of less than 30 seconds. Additionally, once the fire is extinguished, the aqueous foam made with the perfluoroalkyl surfactant can prevent the fire from reigniting.

Due to many of the desired properties such as high chemical resistance, high hydrophobicity, and high lipophobicity, perfluoroalkyl substances (PFAS) have found wide-spread use. However, PFAS such as perfluoroalkyl surfactants, have been shown to decompose or otherwise degrade under environmental conditions to give numerous fluorochemicals, some of which have been found to be environmentally persistent. As such, PFAS are increasingly being phased out of production and use, leading to many widely utilized perfluoroalkyl surfactants and compositions containing them becoming unavailable for continued use.

Firefighting foam formulators have so far not identified a PFAS-free product that can deliver the same performance in fighting fires as the benchmark aqueous foam containing perfluoroalkyl surfactants. The PFAS-free products on the market are either too slow to spread on fire, or the foams are not stable long enough over the fuel to allow effective fire extinction. Some foams that work over fuel oil are not suitable for firefighting applications involving flammable solvents such as alcohols.

There is an industry need to provide firefighting foam, which are free of PFAS. More particularly, there is an industry need for a firefighting foam that is PFAS-free and that is stable over both polar and nonpolar fuels.

### SUMMARY

A foam stabilizing composition and method for its preparation are provided herein. The foam stabilizing composition comprises: a) colloidal silica, b) a siloxane cationic surfactant, and water. A firefighting foam comprising the foam stabilizing composition, and methods for preparation and use of the firefighting foam, are also provided.

### DETAILED DESCRIPTION

The foam stabilizing composition (composition) comprises a) colloidal silica and b) the siloxane cationic surfactant, and water. This composition may optionally further comprise one or more additional starting materials selected from the group consisting of c) an organic cationic surfactant, d) a carrier vehicle (i.e., other than water), e) an additional surfactant (i.e., a surfactant which may be cationic, nonionic or amphoteric, provided that e) the additional surfactant differs from starting materials b) and c), f) a rheology modifier, g) a pH control agent, and h) a foam enhancer. The carrier vehicle d) may comprise water, and the foam stabilizing composition typically comprises a) colloidal silica, b) the siloxane cationic surfactant, and d) water. The foam stabilizing composition may be utilized in foam compositions (i.e., foams), including aqueous foam compositions, expanded foam compositions, concentrated foam compositions and/or foam concentrates, which may be formulated and/or utilized in diverse end-use applications. For example, the foam stabilizing composition described herein may be used to prepare a foam or foaming composition suitable for use in firefighting applications (i.e., extinguishing, suppressing, and/or preventing fire).

### a) Colloidal Silica

The foam stabilizing composition comprises a) colloidal silica. Colloidal silica is made up of silicon dioxide (SiO₂) particles that acquire a negative surface charge when dispersed in alkaline water, primarily through the dissociation of proton from the terminal silanol (SiOH) groups. Such particles are commercially available from various sources, e.g., under the tradename NALCO™ from Ecolab; under the tradename LUDOX™ from W.R. Grace & Co. of Colombia, Maryland, USA or Sigma-Aldrich, Inc. of St. Louis, Missouri, USA. Colloidal silica particles with a size of at least 1 nm, alternatively at least 2 nm, alternatively at least 3 nm, alternatively at least 5 nm, and alternatively at least 10 nm may be used, while at the same time, the size of the colloidal silica particles may be up to 100 nm, alternatively up to 75 nm, alternatively up to 50 nm, alternatively up to 25, nm, and alternatively up to 20 nm.

Alternatively, particle size may be 1 nm to 100 nm, alternatively 1 nm to 20 nm, alternatively 2 nm to 20 nm, and alternatively 10 nm to 20 nm. Particle size of the colloidal silica can be measured via laser diffraction, which is a standardized method according to the International Standard ISO 13320 suitable for measuring particle sizes from 0.01 μm to 3,500 μm of spherical particles.

Without wishing to be bound by theory, it is thought that if the particle size is >100 nm, the colloidal silica will not be able to diffuse quickly to an air-water interface of a firefighting foam, and the firefighting foam prepared using the composition would suffer from poor foamability, but if the particle size is <1 nm, then it is thought that the interface will not be sufficiently rigid, and the firefighting foam could suffer from inferior foam stability.

The amount of colloidal silica in the composition is sufficient to provide 1:10⁻⁴ to 1:1 weight part of colloidal silica : weight part of a cationic surfactant (i.e., weight part of cationic surfactant refers to the weight of b) the siloxane cationic surfactant, and combined with the weight of c) the organic cationic surfactant, when present). Without wishing to be bound by theory, it is thought that if the amount of colloidal silica is too high (e.g., >1 weight part on the basis described above), a gel may form, and it may be difficult to form a foam using the composition, and/or a firefighting foam prepared using the composition may be unstable. However, if the amount of colloidal silica is too low (e.g., <10⁻⁴ weight part on the basis above), then the air-water interface of the firefighting foam may have insufficient colloidal silica particles, resulting in insufficient rigidity and/or stability of the firefighting foam.

### b) Siloxane Cationic Surfactant

The foam stabilizing composition further comprises starting material b), the siloxane cationic surfactant. The siloxane cationic surfactant may comprise a water soluble/dispersible onium compound or amine containing compound with 1 or more siloxane chains (in linear, branched, hyperbranched, rake, pendant, terminal architectures).

The siloxane cationic surfactant may be a complex comprising a cationic organosilicon compound charge-balanced with a counter ion. The siloxane cationic surfactant b) may comprise a siloxane moiety and one or more quaternary ammonium moieties. The siloxane cationic surfactant may have general formula (b-I): [Z¹-D¹-N(Y)ₐ(R)₂₋ₐ]^{+y} [X^{-x}]ₙ, where Z¹ is a siloxane moiety; D¹ is a divalent linking group; R is H or an unsubstituted hydrocarbyl group having from 1 to 4 carbon atoms; each Y has formula -D-NR¹₃+, where D is a divalent linking group and each R¹ is independently an unsubstituted hydrocarbyl group having from 1 to 4 carbon atoms; subscript a is 1 or 2; 1≤y≤3; X is an anion; subscript n is 1, 2, or 3; and 1≤x≤3, with the proviso that (x*n)=y.

With regard to formula (b-I), as introduced above, Z¹ represents a siloxane moiety. In general, the siloxane moiety Z¹ comprises a siloxane and is otherwise not particularly limited. As understood in the art, siloxanes comprise an inorganic silicon-oxygen-silicon group (i.e., —Si—O—Si—), with organosilicon and/or organic side groups attached to the silicon atoms. As such, siloxanes may be represented by the general formula:

([R^{x}ᵢSiO_{(4-i)/2}]ₕ)ⱼ(R^{x})₃₋ⱼSi—, where subscript i is independently selected from 1, 2, and 3 in each moiety indicated by subscript h, subscript h is at least 1, subscript j is 1, 2, or 3, and each R^{x} is independently selected from hydrocarbyl groups, alkoxy and/or aryloxy groups, and siloxy groups.

Hydrocarbyl groups suitable for R^{x} include monovalent hydrocarbon moieties, which may independently be substituted or unsubstituted, linear, branched, cyclic, or combinations thereof, and saturated or unsaturated. With regard to such hydrocarbyl groups, the term “unsubstituted” describes hydrocarbon moieties composed of carbon and hydrogen atoms, i.e., without heteroatom substituents. The term “substituted” describes hydrocarbon moieties where either at least one hydrogen atom is replaced with an atom or group other than hydrogen (e.g. an alkoxy group, or an amine group) (i.e., as a pendant or terminal substituent), a carbon atom within a chain/backbone of the hydrocarbon is replaced with an atom other than carbon (e.g. a heteroatom, such as oxygen, sulfur, or nitrogen) (i.e., as a part of the chain/backbone), or both. As such, suitable hydrocarbyl groups may comprise, or be, a hydrocarbon moiety having one or more substituents in and/or on (i.e., appended to and/or integral with) a carbon chain/backbone thereof, such that the hydrocarbon moiety may comprise, or be, e.g., an ether or an ester. Linear and branched hydrocarbyl groups may independently be saturated or unsaturated and, when unsaturated, may be conjugated or nonconjugated. Cyclic hydrocarbyl groups may independently be monocyclic or polycyclic, and encompass cycloalkyl groups, aryl groups, and heterocycles, which may be, e.g., aromatic or saturated and nonaromatic and/or non-conjugated. Examples of combinations of linear and cyclic hydrocarbyl groups include alkaryl groups and aralkyl groups. General examples of hydrocarbon moieties suitably for use in or as the hydrocarbyl group include alkyl groups, aryl groups, alkenyl groups, alkynyl groups, and combinations thereof. Examples of alkyl groups include methyl, ethyl, propyl (e.g. iso-propyl and/or n-propyl), butyl (e.g. isobutyl, n-butyl, tert-butyl, and/or sec-butyl), pentyl (e.g. isopentyl, neopentyl, and/or tert-pentyl), hexyl, and other linear or branched saturated hydrocarbon groups, e.g. having greater than 6 carbon atoms. Examples of aryl groups include phenyl, tolyl, xylyl, naphthyl, benzyl, dimethyl phenyl, which may overlap with alkaryl groups (e.g. benzyl) and aralkyl groups (e.g. tolyl and dimethyl phenyl). Examples of alkenyl groups include vinyl, allyl, propenyl, isopropenyl, butenyl, isobutenyl, pentenyl, heptenyl, hexenyl, and cyclohexenyl groups.

Alkoxy and aryloxy groups suitable for R^{x} include those having the general formula —OR^{xi}, where R^{xi} is one of the hydrocarbyl groups set forth above with respect to R^{x}. Examples of alkoxy groups include methoxy, ethoxy, propoxy, butoxy, and benzyloxy. Examples of aryloxy groups include phenoxy, and tolyloxy.

Examples of suitable siloxy groups suitable for R^{x} include [M], [D], [T], and [Q] units, which, as understood in the art, each represent structural units of individual functionality present in siloxanes, such as organosiloxanes and organopolysiloxanes. More specifically, [M] represents a monofunctional unit of general formula R^{xii}₃SiO_{1/2}; [D] represents a difunctional unit of general formula R^{xii}₂SiO_{2/2}; [T] represents a trifunctional unit of general formula R^{xii}SiO_{3/2}; and [Q] represents a tetrafunctional unit of general formula SiO_{4/2}, as shown by the general structural moieties below:

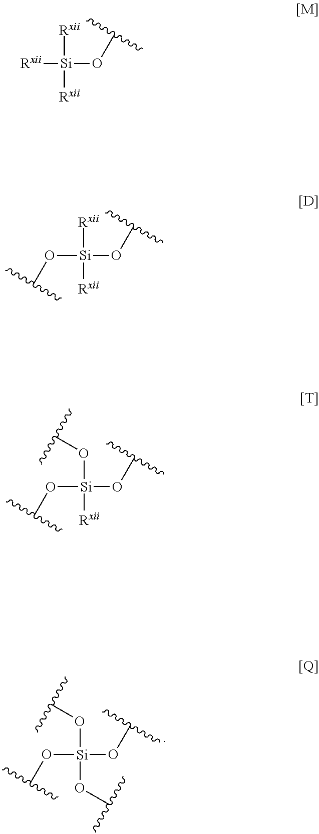

In these general structural moieties, each R^{xii} is independently a monovalent or polyvalent substituent. As understood in the art, specific substituents suitable for each R^{xii} are not limited, and may be monoatomic or polyatomic, organic or inorganic, linear or branched, substituted or unsubstituted, aromatic, aliphatic, saturated or unsaturated, and combinations thereof. Typically, each R^{xii} is independently selected from hydrocarbyl groups, alkoxy and/or aryloxy groups, and siloxy groups. As such, each R^{xii} may independently be a hydrocarbyl group of formula —R^{xi} or an alkoxy or aryloxy group of formula —OR^{xi}, where R^{xi} is as defined above, or a siloxy group represented by any one, or combination, of [M], [D], [T], and/or [Q] units described above.

The siloxane moiety Z¹ may be linear, branched, or combinations thereof, e.g. based on the number and arrangement of [M], [D], [T], and/or [Q] siloxy units present therein. When branched, the siloxane moiety Z¹ may minimally branched or, alternatively, may be hyperbranched and/or dendritic.

Alternatively, the siloxane moiety Z¹ may be a branched siloxane moiety having the formula —Si(R³)₃, where at least one R³ is —OSi(R⁴)₃ and each other R₃ is independently selected from R² and —OSi(R⁴)₃, where each R⁴ is independently selected from R², —OSi(R⁵)₃, and —[OSiR²₂]ₘOSiR²₃. With regard to these selections for R⁴, each R⁵ is independently selected from R², —OSi(R⁶)₃, and —[OSiR²₂]ₘOSiR²₃, and each R⁶ is independently selected from R² and —[OSiR²₂]ₘOSiR²₃. In each selection, R₂ is an independently selected substituted or unsubstituted hydrocarbyl group, such as any of those described above with respect to R^{x}, and each subscript m is individually selected such that 0≤m≤100 (i.e., in each selection where applicable).

As introduced above, each R³ is selected from R² and —OSi(R⁴)₃, with the proviso that at least one R³ is of formula —OSi(R⁴)₃. Alternatively, at least two of R³ may be of formula —OSi(R⁴)₃. Alternatively, each R³ may be of formula —OSi(R⁴)₃. It will be appreciated that a greater number of R³ being —OSi(R⁴)₃ increases the level of branching in the siloxane moiety Z¹. For example, when each R³ is —OSi(R⁴)₃, the silicon atom to which each R³ is bonded is a T siloxy unit. Alternatively, when two of R³ are of formula OSi(R⁴)₃, the silicon atom to which each R³ is bonded is a [D] siloxy unit. Moreover, when R³ is of formula —OSi(R⁴)₃, and when R⁴ is of formula —OSi(R⁵)₃, further siloxane bonds and branching are present in the siloxane moiety Z¹. This is further the case when R⁵ is of formula —OSi(R⁶)₃. As such, it will be understood by those of skill in the art that each subsequent R³⁺ⁿ moiety in the siloxane moiety Z¹ can impart a further generation of branching, depending on the particular selections thereof. For example, R⁴ can be of formula —OSi(R₅)₃, and R⁵ can be of formula —OSi(R⁶)₃. Thus, depending on a selection of each substituent, further branching attributable to [T] and/or [Q] siloxy units may be present in the siloxane moiety Z¹ (i.e., beyond those of other substituents/moieties described above).

Each R⁴ is selected from R², —OSi(R⁵)₃, and —[OSiR²₂]ₘOSiR²₃, where 0≤m≤100. Depending on a selection of R⁴ and R⁵, further branching can be present in the siloxane moiety Z¹. For example, when each R⁴ is R², then each —OSi(R⁴)₃ moiety (i.e., each R³ of formula —OSi(R⁴)₃) is a terminal [M] siloxy unit. Said differently, when each R³ is —OSi(R⁴)₃, and when each R⁴ is R², then each R³ can be written as —OSiR²₃ (i.e., an [M] siloxy unit). Alternatively, the siloxane moiety Z¹ may include a [T] siloxy unit bonded to group D in formula (I), which [T] siloxy unit is capped by three [M] siloxy units. Moreover, when of formula —[OSiR²₂]ₘOSiR²₃, R⁴ includes optional [D] siloxy units (i.e., those siloxy units in each moiety indicated by subscript m) as well as an [M] siloxy unit (i.e., represented by OSiR²₃). As such, when each R³ is of formula —OSi(R⁴)₃ and each R⁴ is of formula —[OSiR²₂]ₘOSiR²₃, then each R³ includes a [Q] siloxy unit. Alternatively, each R³ may be of formula —OSi([OSiR²₂]ₘOSiR²₃)₃, such that when each subscript m is 0, each R³ is a [Q] siloxy unit endcapped with three [M] siloxy units. Likewise, when subscript m is greater than 0, each R³ includes a linear moiety (i.e., a diorganosiloxane moiety) with a degree of polymerization being attributable to subscript m.

As set forth above, each R⁴ can also be of formula —OSi(R⁵)₃. Alternatively, when one or more R⁴ is of formula —OSi(R⁵)₃, further branching can be present in the siloxane moiety Z¹ depending on selection of R⁵. More specifically, each R⁵ may be selected from R², —OSi(R⁶)₃, and —[OSiR²₂]ₘOSiR²₃, where each R⁶ may be selected from R² and —[OSiR²₂]ₘOSiR²₃, and where each subscript m is defined above.

Subscript m is 0 to 100, alternatively 0 to 80, alternatively 0 to 60, alternatively 0 to 40, alternatively 0 to 20, alternatively 0 to 19, alternatively 0 to 18, alternatively 0 to 17, alternatively 0 to 16, alternatively 0 to 15, alternatively 0 to 14, alternatively 0 to 13, alternatively 0 to 12, alternatively 0 to 11, alternatively 0 to 10, alternatively 0 to 9, alternatively 0 to 8, alternatively 0 to 7, alternatively 0 to 6, alternatively 0 to 5, alternatively 0 to 4, alternatively 0 to 3, alternatively 0 to 2, alternatively 0 to 1, and alternatively m may be 0. Alternatively, each subscript m may be 0, such that the siloxane moiety Z¹ is free from [D] siloxy units.

Each of R², R³, R⁴, R⁵, and R⁶ are independently selected. As such, the descriptions above relating to each of these substituents is not meant to mean or imply that each substituent is the same. Rather, any description above relating to R⁴, for example, may relate to only one R⁴ or any number of R⁴ in the siloxane moiety Z¹, and so on. In addition, different selections of R², R³, R⁴, R⁵, and R⁶ can result in the same structures. For example, if R³ is —OSi(R⁴)₃, and if each R⁴ is —OSi(R⁵)₃, and if each R⁵ is R², then R³ can be written as —OSi(OSiR²₃)₃. Similarly, if R³ is —OSi(R⁴)₃, and if each R⁴ is —[OSiR²₂]ₘOSiR²₃, R³ can be written as —OSi(OSiR²₃)₃ when subscript m is 0. As shown, these particular selections result in the same final structure for R₃, based on different selections for R⁴. Alternatively, R³, R⁴, R⁵, and R⁶ may be selected such that the siloxane cationic surfactant has an average of 3 to 10 silicon atoms per molecule; alternatively 3 to 6 silicon atoms per molecule. To that end, any proviso of limitation on final structure of the siloxane moiety Z¹ is to be considered met by an alternative selection that results in the same structure required in the proviso.

Alternatively, each R² may be an independently selected alkyl group. Alternatively, each R² may be an independently selected alkyl group having from 1 to 10, alternatively from 1 to 8, alternatively from 1 to 6, alternatively from 1 to 4, alternatively from 1 to 3, alternatively from 1 to 2 carbon atom(s). Alternatively, each R² may be methyl.

Alternatively, each subscript m may be 0 and each R² may be methyl, and the siloxane moiety Z¹ may have one of the following structures (i)-(iv):

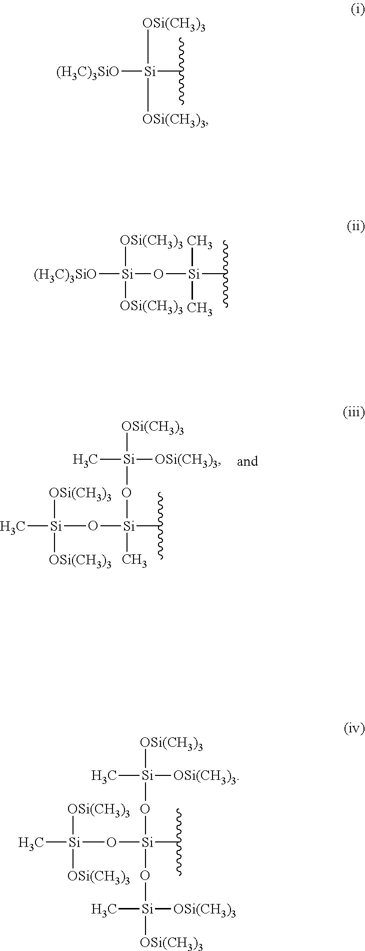

With further regard to the siloxane cationic surfactant and formula (I), as introduced above, D¹ is a divalent linking group. The divalent linking group D¹ is not particularly limited. Typically, divalent linking group D¹ is selected from divalent hydrocarbon groups. Examples of such hydrocarbon groups include divalent forms of the hydrocarbyl and hydrocarbon groups described above, such as any of those set forth above with respect to R^{x}. As such, it will be appreciated that suitable hydrocarbon groups for the divalent linking group D¹ may be substituted or unsubstituted, and linear, branched, and/or cyclic.

Alternatively, divalent linking group D¹ may comprise, alternatively divalent linking group D¹ is, a linear or branched alkyl and/or alkylene group. Alternatively, divalent linking group D¹ may comprise, alternatively divalent linking group D¹ is, a C₁-C₁₈ hydrocarbon moiety, such as a linear hydrocarbon moiety having the formula —(CH₂)_{d}—, where subscript d is from 1 to 18. Alternatively, subscript d may be 1 to 16, alternatively 1 to 12, alternatively 1 to 10, alternatively 1 to 8, alternatively 1 to 6, alternatively 2 to 6, alternatively 2 to 4. Alternatively, subscript d may be 3, such that divalent linking group D¹ comprises a propylene (i.e., a chain of 3 carbon atoms). As will be appreciated by those of skill in the art, each unit represented by subscript d is a methylene unit, such that linear hydrocarbon moiety may be defined or otherwise referred to as an alkylene group. It will also be appreciated that each methylene group may independently be unsubstituted and unbranched, or substituted (e.g. with a hydrogen atom replaced with a non-hydrogen atom or group) and/or branched (e.g. with a hydrogen atom replaced with an alkyl group). Alternatively, divalent linking group D¹ may comprise, alternatively divalent linking group D¹ is, an unsubstituted alkylene group. Alternatively, divalent linking group D¹ may comprise, alternatively divalent linking group D¹ is, a substituted hydrocarbon group, such as a substituted alkylene group. Alternatively, for example, divalent linking group D¹ may comprise a carbon backbone having at least 2 carbon atoms and at least one heteroatom (e.g. O, N, S, or P), such that the backbone comprises an ether moiety, amine moiety, mercapto moiety, or phosphorous moiety.

Alternatively, divalent linking group D¹ may comprise, alternatively divalent linking group D¹ is, an amino substituted hydrocarbon group (i.e., a hydrocarbon comprising a nitrogen-substituted carbon chain/backbone). For example, the divalent linking group D¹ may be an amino substituted hydrocarbon having formula -D³-N(R⁷)-D³-, such that the siloxane cationic surfactant b) may be represented by the following formula: [Z¹-D³-N(R⁷)-D³-N(Y′)ₐ(R)₂₋ₐ]^{+y} [X^{-x}]ₙ, where each D³ is an independently selected divalent linking group, Z¹ is as defined and described above, R⁷ is Y′ or H, and each R, subscript a, X, superscript y, superscript x, and subscript n is as defined above and described below. Y′ is an independently selected group of formula -D-NR¹₃+, as described above for Y.

As introduced above, each D³ of the amino substituted hydrocarbon divalent linking group is independently selected. Typically, each D³ comprises an independently selected alkylene group, such as any of those described above with respect to divalent linking group D¹. For example, each D³ may be independently selected from alkylene groups having 1 to 8 carbon atoms, alternatively 2 to 8, alternatively 2 to 6, alternatively 2 to 4 carbon atoms. Alternatively, each D³ may be propylene (i.e., —(CH₂)₃—). However, it is to be appreciated that one or both D³ may be, or comprise, another divalent linking group (i.e., aside from the alkylene groups described above). Moreover, each D³ may be substituted or unsubstituted, linear or branched, and various combinations thereof.

As also introduced above, R⁷ of the amino substituted hydrocarbon is H or quaternary ammonium moiety Y′ (i.e., of formula -D-NR¹₃+, as set forth above). For example, R⁷ may be H, such that the siloxane cationic surfactant b) may be represented by the following formula: [Z¹-D³-NH-D³-N(Y′)ₐ(R)₂₋ₐ]^{+y} [X^{-x}]ₙ, where each D³ and Z¹ is as defined and described above and each Y′, R, subscript a, X, superscript y, superscript x, and subscript n is as defined above and described below. Alternatively, superscript y may be 1 or 2, controlled by subscript a. More particularly, the number of quaternary ammonium moieties Y′ will be controlled by subscript a as 1 or 2, providing a total cationic charge of +1 or +2, respectively. Accordingly, superscript x may also be 1 or 2, such that the siloxane cationic surfactant b) will be charge balanced.

Alternatively, R⁷ of the amino substituted hydrocarbon may be the quaternary ammonium moiety Y′, such that the siloxane cationic surfactant b) may be represented by the following formula:

[Z¹-D³-NY-D³-N(Y′)ₐ(R)₂₋ₐ]^{+y} [X^{-x}]ₙ, where each D³ and Z¹ is as defined and described above and each Y′, R, subscript a, X, superscript y, superscript x, and subscript n is as defined above and described below. Alternatively, y=a+1, such that superscript y is 2 or 3. More particularly, the number of quaternary ammonium moieties will include the Y′ of R⁷ as well as the 1 or 2 quaternary ammonium moiety Y′ controlled by subscript a, providing a total cationic charge of +2 or +3, respectively. Accordingly, superscript x may be 1, 2, or 3, such that the siloxane cationic surfactant b) will be charge balanced.

Alternatively, R⁷ may be Y′ and the siloxane moiety Z¹ may be the branched siloxane moiety described above, such that the siloxane cationic surfactant b) may be represented by the following formula:

[(R³)₃Si-D³-N(-D-NR¹₂+)-D³-N(-D-NR¹₃+)ₐ(R)₂₋ₐ]^{+y} [X^{-x}]ₙ, where each D³ and R³ is as defined and described above, and each D, R, R¹, subscript a, X, superscript y, superscript x, and subscript n is as defined above and described below.

Subscript a is 1 or 2. As will be appreciated by those of skill in the art, subscript a indicates whether the quaternary ammonium-substituted amino moiety of the siloxane cationic surfactant b) represented by subformula —N(Y′)ₐ(R)₂₋ₐ has one or two of quaternary ammonium groups Y′ (i.e., the group of subformula (-D-NR¹₃+). Likewise, as each such quaternary ammonium groups Y′, subscript a also indicates the number of counter anions (i.e., number of anions X, as described below) required to balance out the cationic charge from the quaternary ammonium groups Y′ indicated by moieties a. For example, subscript a may be 1, and the siloxane cationic surfactant b) may have the following formula: [Z¹-D¹-N(R)-D-NR¹₃]^{+y} [X^{-x}]ₙ, where Z¹ and D¹ are as defined and described above, and each D, R, R¹, X, superscript y, superscript x, and subscript n is as defined above and described below.

It is to be appreciated that, while subscript a is 1 or 2 in each cationic molecule of the siloxane cationic surfactant b), the siloxane cationic surfactant b) may comprise a mixture of cationic molecules that correspond to formula (b-I) but are different from one another (e.g. with respect to subscript a). As such, while subscript a is 1 or 2, a mixture comprising the siloxane cationic surfactant b) may have an average value of a of from 1 to 2, such as an average value of 1.5 (e.g. from a 50:50 mixture of cationic molecules of the siloxane cationic surfactant b) where a=1 and molecules of the siloxane cationic surfactant b) where a=2.

Each R independently represents H or an unsubstituted hydrocarbyl group having from 1 to 4 carbon atoms, when present (e.g. when subscript a is 1). Alternatively, R may be H. Alternatively, R may be an alkyl group having from 1 to 4 carbon atoms, such as from 1 to 3, alternatively from 1 to 2 carbon atom(s). For example, R may be a methyl group, an ethyl group, a propyl group (e.g. an n-propyl or iso-propyl group), or a butyl group (e.g. an n-butyl, sec-butyl, iso-butyl, or tert-butyl group). Alternatively, each R may be methyl.

Each R¹ represents an independently selected unsubstituted hydrocarbyl group having from 1 to 4 carbon atoms. For example, each R¹ may be independently selected from alkyl groups having from 1 to 4 carbon atoms, such as from 1 to 3, alternatively from 1 to 2 carbon atom(s). Alternatively, each R¹ may be selected from methyl groups, ethyl groups, propyl groups (e.g. n-propyl and iso-propyl groups), and butyl group (e.g. n-butyl, sec-butyl, iso-butyl, and tert-butyl groups). While independently selected, each R¹ may be the same as each other R¹ in the cationic surfactant. For example, each R¹ may be methyl or ethyl. Alternatively, each R¹ may be methyl.

Each D represents an independently selected divalent linking group (“linking group D”). Typically, linking group D is selected from substituted and unsubstituted divalent hydrocarbon groups. Examples of such hydrocarbon groups include divalent forms of the hydrocarbyl and hydrocarbon groups described above, such as any of those set forth above with respect to R^{x}, D¹, and D³. As such, it will be appreciated that suitable hydrocarbon groups for use in or as linking group D may be linear or branched, and may be the same as or different from any other divalent linking group.

Alternatively, linking group D comprises an alkylene group, such as one of those

described above with respect to divalent linking group D¹. For example, linking group D may comprise an alkylene group having from 1 to 8 carbon atoms, such as from 1 to 6, alternatively from 2 to 6, alternatively from 2 to 4 carbon atoms. Alternatively, the alkylene group of linking group D may be unsubstituted. Examples of such alkylene groups include methylene groups, ethylene groups, propylene groups, and butylene groups.

Alternatively, linking group D may comprise, alternatively divalent linking group D is, a substituted hydrocarbon group, such as a substituted alkylene group. For example, linking group D may comprise a carbon backbone having at least 2 carbon atoms, and at least one heteroatom (e.g. O) in the backbone or bonded to one of the carbon atoms thereof (e.g. as a pendant substituent). For example, linking group D may comprise a hydroxyl-substituted hydrocarbon having formula -D′-CH(—(CH₂)ₑ—OH)-D′-, where each D′ is independently a covalent bond or a divalent linking group, and subscript e is 0 or 1. Alternatively, at least one D′ may comprise an independently selected alkylene group, such as any of those described above. For example, each D′ may be independently selected from alkylene groups having from 1 to 8 carbon atoms, such as from 1 to 6, alternatively from 1 to 4, alternatively from 1 to 2 carbon atoms. Alternatively, each D′ may be methylene (i.e., —CH₂—). However, it is to be appreciated that one or both D′ may be, or may comprise, another divalent linking group (i.e., aside from the alkylene groups described above).

Alternatively, each linking group D may be an independently selected hydroxypropylene group (i.e., where each D′ is an independently selected from the covalent bond and methylene, with the provisos that at least one D′ is the covalent bond when subscript e is 1, and each D′ is methylene when subscript e is 0). Accordingly, each linking group D may be independently of one of the following formulas:

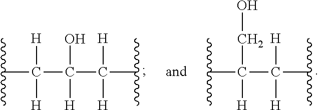 [SMILES: *CC(O)C* ; *CC(*)CO]

Alternatively, siloxane moiety Z¹ may be the branched siloxane moiety, divalent linking group D may be the amino substituted hydrocarbon where each D³ is propylene and R⁷ is H, subscript a is 1, R is H, each linking group D is a (2-hydroxy)propylene group, each R¹ is methyl, and X is a monoanion, such that the siloxane cationic surfactant b) of formula (b-I) has the following formula:

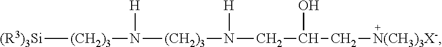

where each R³ is as defined and described above, and X is as defined above and described below. Alternatively, the siloxane cationic surfactant b) may be configured the same as described immediately above, but with subscript a=2, such that the siloxane cationic surfactant b) of formula (b-I) has the following formula:

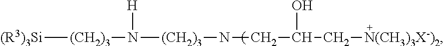

where each R³ is as defined and described above, and each X is as defined above and described below. Alternatively, the siloxane cationic surfactant b) may be configured the same as described immediately above, but with R⁷ being the quaternary ammonium moiety Y′, such that the siloxane cationic surfactant b) of formula (b-I) has the following formula:

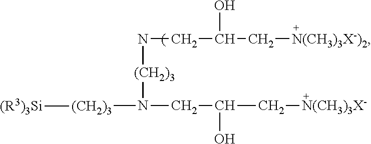

where each R³ is as defined and described above, and each X is as defined above and described below. Alternatively, the siloxane cationic surfactant b) may be configured the same as described immediately above, but with subscript a=1 and R being H, such that the siloxane cationic surfactant b) of formula (b-I) has the following formula:

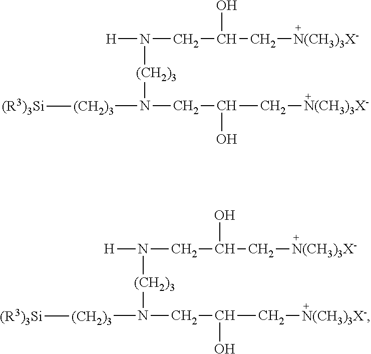

where each R³ is as defined and described above, and each X is as defined above and described below.

Each X is an anion having a charge represented by superscript x. Accordingly, as will be understood by those of skill in the art, X is not particularly limited and may be any anion suitable for ion-pairing/charge-balancing one or more cationic quaternary ammonium moieties Y and Y′. As such, each X may be an independently selected monoanion or polyanion (e.g. dianion or trianion), such that one X may be sufficient to counterbalance two or more cationic quaternary ammonium moieties Y′. As such, the number of anions X (i.e., subscript n) will be readily selected based on the number of cationic quaternary ammonium moieties Y′ and the charge of X selected (i.e., superscript x).

Examples of suitable anions include organic anions, inorganic anions, and combinations thereof. Typically, each anion X is independently selected from monoanions that are unreactive the other moieties of the cationic surfactant. Examples of such anions include conjugate bases of medium and strong acids, such as halide ions (e.g. chloride, bromide, iodide, fluoride), sulfates (e.g. alkyl sulfates), sulfonates (e.g. benzyl or other aryl sulfonates) as well as combinations thereof. Other anions may also be utilized, such as phosphates, nitrates, organic anions such as carboxylates (e.g. acetates) as well as combinations thereof. It is to be appreciated that derivatives of such anions include polyanionic compounds comprising two or more functional groups for which the above examples are named. For example, mono and/or polyanions of polycarboxylates (e.g. citric acid) are encompassed by the anions above. Other examples of anions include tosylate anions.

Alternatively, each anion X may be an inorganic anion having one to three valences. Examples of such anions include monoanions such as chlorine, bromine, iodine, aryl sulfonates having six to 18 carbon atoms, nitrates, nitrites, and borate anions, dianions such as sulfate and sulfite, and trianions such as phosphate. Alternatively, each X may be a halide anion, alternatively each X may be chloride (i.e., Cl⁻) or iodide (i.e., I⁻); alternatively each X may be chloride.

Alternatively, b) the siloxane cationic surfactant may have general formula (b-II):

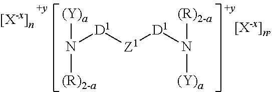

where Z¹ is a divalent siloxane moiety, D¹, Y, R, a, n, x, and y are as described above. Alternatively, in general formula (b-II), Z¹ may be substantially linear; alternatively, Z¹ may be linear. Z¹ may comprise, alternatively consist essentially of, alternatively consist of, difunctional units of general formula R^{xii}₂SiO_{2/2}, as described above.

The divalent siloxane moiety Z¹ comprises an inorganic silicon-oxygen-silicon group (i.e., —Si—O—Si—), with organosilicon and/or organic side groups attached to the silicon atoms. As such, divalent siloxane moieties may be represented by the general formula

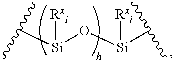

where each subscript i is independently selected from 0, 1, or 2; subscript h≥1, and each R^{x} is independently selected from hydrocarbyl groups, alkoxy and/or aryloxy groups, and siloxy groups, as defined and described above. Alternatively, the divalent siloxane moiety Z1 may comprise a linear siloxane moiety having the formula:

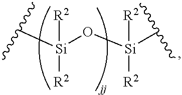

where R2 is R^{xii} is as described above, and subscript jj≥1 while at the same time subscript jj≤20. Alternatively, each R² may be an independently selected hydrocarbyl group, alternatively each R² may be an independently selected alkyl group. Alternatively, subscript jj may be 2 to 15; alternatively 3 to 14. Alternatively, each R² may be an independently selected alkyl group having from 1 to 10, alternatively from 1 to 8, alternatively from 1 to 6, alternatively from 1 to 4, alternatively from 1 to 3, alternatively from 1 to 2 carbon atom(s). Alternatively, the divalent siloxane moiety Z¹ may have formula:

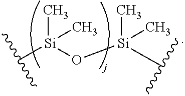

Alternatively, subscript jj may be 3 or 14, and each R² may be methyl, and the siloxane moiety Z¹ has one of the following structures (i)-(ii):

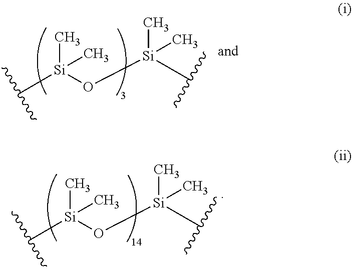

Alternatively, in the formula above for the siloxane cationic surfactant (b-II), when D¹ is an alkylene group as described above, the siloxane cationic surfactant (b-II) may have general formula:

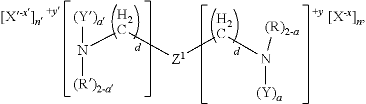

where Z¹ and subscript d are as defined and described above, and each Y, Y′, R, subscript a, X, superscript y, superscript x, and subscript n is described above. Furthermore, subscript a′, subscript n′ superscript x′, superscript y′, Y′, R′, and X′ are each independently selected. Subscript a′ may be as described above for subscript a. Subscript n′ may be as described above for subscript n. Superscript x may be as described above for superscript x′. Superscript y′ may be as described above for superscript y. R′ is as described above for R. X′ is an anion as described above for X. Alternatively, as will be appreciated from the further description below, superscript y is independently 1 or 2, controlled by subscript a; and similarly superscript y′ is independently 1 or 2, controlled by subscript a′. More particularly, the number of quaternary ammonium moieties Y and Y′ will be controlled by each subscript a as 1 or 2 and subscript a′ as 1 or 2, providing a total cationic charge of +2 to +4. Each superscript x will also be 1 or 2, and each superscript x′ will also be 1 or 2, such that the siloxane cationic surfactant (A) will be charge balanced. Alternatively, in the general formula above, when subscript a=1 and subscript a=1), the siloxane cationic surfactant (b-II) may have the following formula:

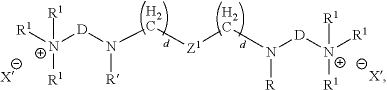

where Z¹, R¹, R, R′, and D, and subscript d are as defined and described above. Alternatively, in this formula, each D may be may be the substituted hydrocarbon group, such as the hydroxyl-substituted hydrocarbon group described above. Alternatively, each D may be may be independently of one of the following formulas:

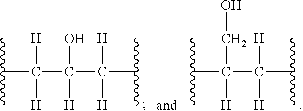 [SMILES: *CC(O)C* ; ";" ; "and" ; *CC(*)CO ; "."]

Alternatively, when subscript a=2 and subscript a′=2 in the general formula above, the siloxane cationic surfactant (b-II) may have the following formula:

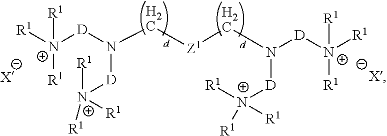

where Z¹, D, R¹, and subscript d are as defined and described above. Alternatively, in this formula, each D may be may be the substituted hydrocarbon group, such as the hydroxyl-substituted hydrocarbon group described above. Alternatively, each D may be may be independently of one of the following formulas:

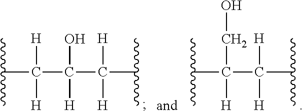 [SMILES: *CC(O)C* ; ";" ; "and" ; *CC(*)CO ; "."]

Alternatively, in the general formula for the siloxane cationic surfactant (b-II), the divalent linking group D¹ may comprise, alternatively may be, an amino substituted hydrocarbon group (i.e., a hydrocarbon comprising a nitrogen-substituted carbon chain/backbone). For example, the divalent linking group D¹ may be an amino substituted hydrocarbon having formula -D³-N(R⁷)-D³-, such that the siloxane cationic surfactant (b-II) may be represented by the following formula:

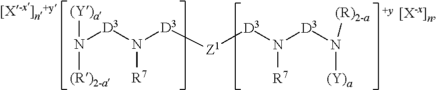

where D³, Z¹, R⁷, Y, Y′, R, R′, subscript a, subscript a′, X, X′, superscript y, superscript y′, superscript x, superscript x′, subscript n, and subscript n′ are as described above. In this formula, when each R7 is H, the siloxane cationic surfactant (b-II) may be represented by the

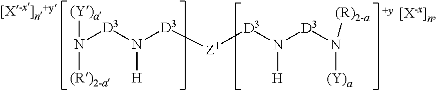

following formula: where D3, z1, R7, Y, Y′, R, R′, subscript a, subscript a′, X, X′, superscript y, superscript y′, superscript x, superscript x′, subscript n, and subscript n′ are as described above. Alternatively, when R7 of the amino substituted hydrocarbon is the quaternary ammonium moiety Y, such that the siloxane cationic surfactant (b-II) may be represented by the following formula:

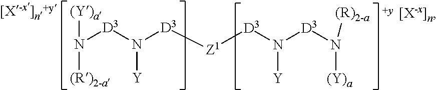

where D³, Z¹, Y, Y′, R, R′, subscript a, subscript a′, X, X′, superscript y, superscript y′, superscript x, superscript x′, subscript n, and subscript n′ are as described above. Alternatively, y=a+1, such that superscript y is 2 or 3. Alternatively, y′=a′+1, such that superscript y′ is 2 or 3. More particularly, the number of quaternary ammonium moieties will include the Y of R⁷ as well as the 1 or 2 quaternary ammonium moiety Y and Y′ controlled by subscript a and subscript a′, respectively, providing a total cationic charge of +4 to +6. Accordingly, in such embodiments, superscript x will be 1, 2, or 3, and subscript x′ will be 1, 2, or 3, such that the siloxane cationic surfactant (A) will be charge balanced.

Alternatively, b) the siloxane cationic surfactant of general formula (b-II) may have a formula such as:

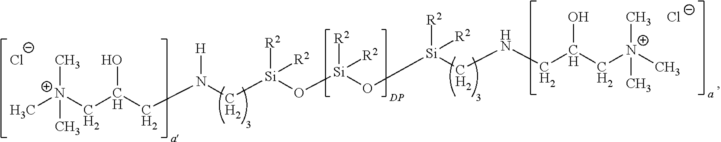

where R², subscript a, and subscript a′ are as described above, and subscript DP represents degree of polymerization of the divalent siloxane moiety Z¹. Subscript DP may have a value of 0 to 20, alternatively 2 to 15, alternatively 2 to 13. Alternatively, the siloxane cationic surfactant may have a formula such as:

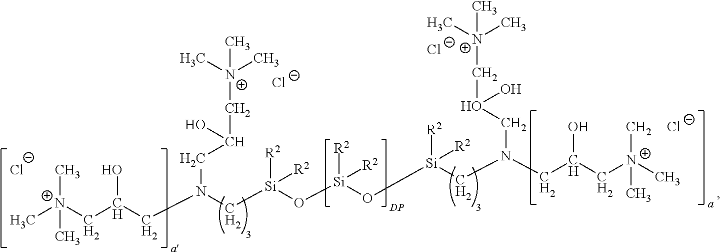

where R², subscript a, subscript a′, and subscript DP are as described above.

Alternatively, the composition may comprise a siloxane cationic surfactant b) having one of the following formulas (b-i)-(b-x):

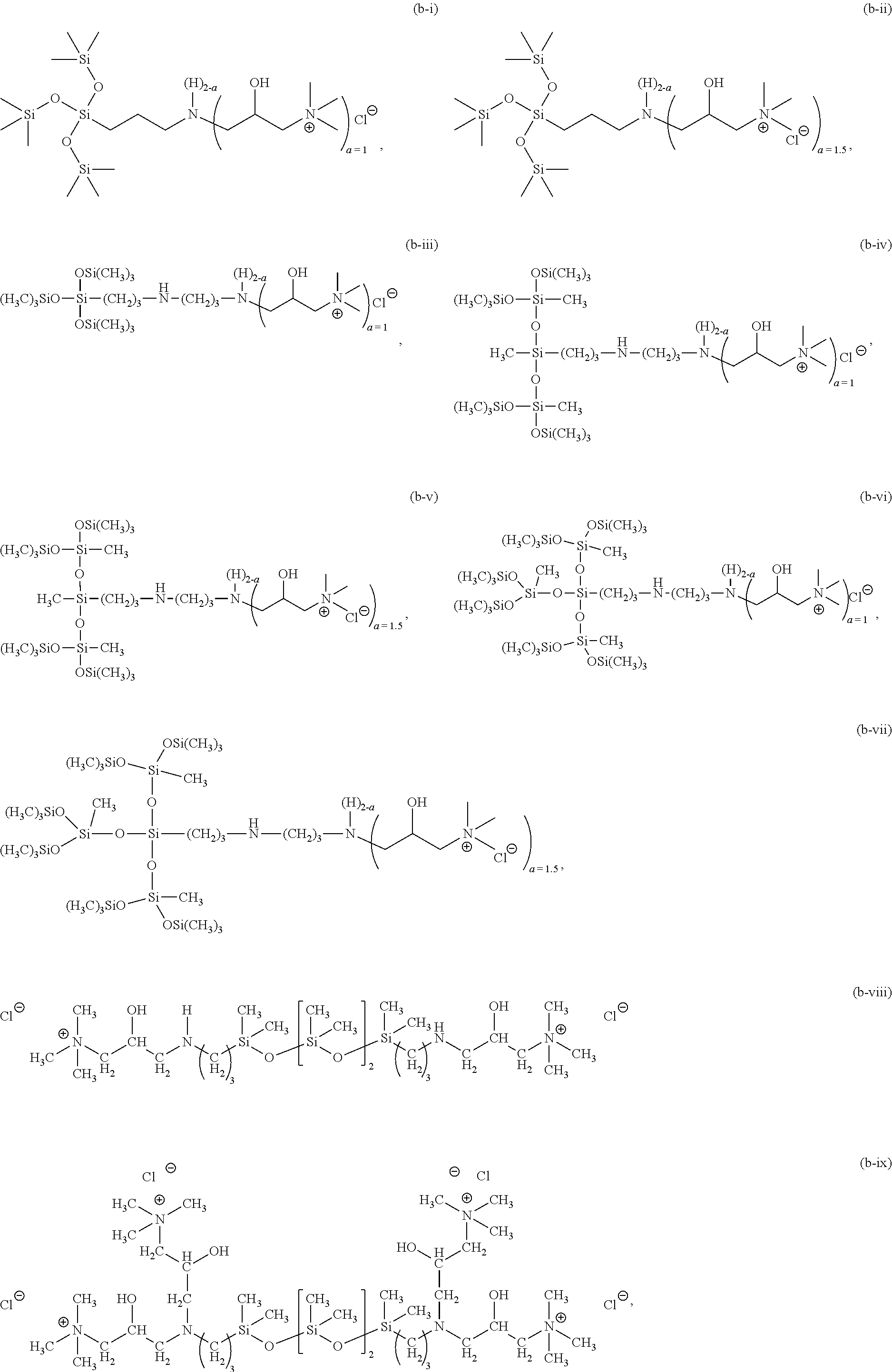

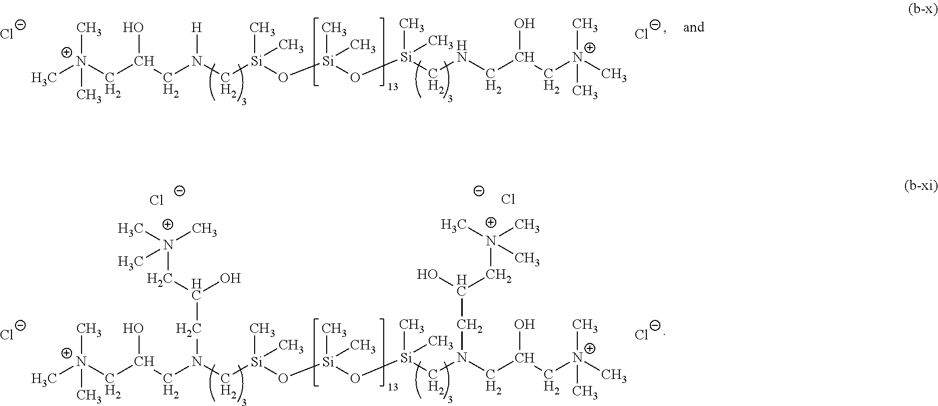

Alternatively, the siloxane cationic surfactant b) may have formula

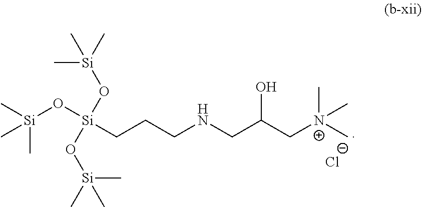

The siloxane cationic surfactant b) may comprise a combination or two or more different siloxane cationic surfactants above that differ in at least one property such as structure, molecular weight, degree of branching, silicon and/or carbon content, number of cationic quaternary ammonium groups Y and/or Y′ (e.g., when subscript a (and subscript a′) represents an average value). Siloxane cationic surfactants may be prepared by the method described in U.S. Provisional Patent Application Serial No. 62/955192 filed on 30 Dec. 2019, which is hereby incorporated by reference, by varying appropriate starting materials, as exemplified below in in the Reference Examples for preparing siloxane cationic surfactants. The method comprises: reacting (a) an amino-functional polyorganosiloxane and (b) a quaternary ammonium compound to give the siloxane cationic surfactant. The amino-functional polyorganosiloxane (a) comprises formula: Z¹(-D⁵-NHR)ₐ, where Z¹ is the siloxane moiety described above, D⁵ is a covalent bond or an unsubstituted divalent hydrocarbyl group, as described above, R is H or the unsubstituted hydrocarbyl group having from 1 to 4 carbon atoms described above, and subscript a is 1 or more, depending on the functionality of Z¹. For example, when Z¹ is the divalent siloxane moiety, subscript a=2.

Alternatively, D⁵ in the formula for the amino-functional polyorganosiloxane (a) above may the divalent linking group, such that the amino-functional polyorganosiloxane (a) has the formula ([R^{x}ᵢSiO_{(4-i)/2}]ₕ)ⱼ(R^{x})₃₋ⱼSi-D⁵-NHR, where R^{x} D⁵, R, subscript h, subscript i, and subscript j are independently selected and as defined above. Alternatively, the siloxane moiety Z¹ may be the branched siloxane moiety such that the amino-functional polyorganosiloxane (a) is a branched aminosiloxane having formula (R³)₃Si-D⁵-NHR, where R, divalent linking group D⁵, and the branched organosilicon moiety represented by the subformula (R³)₃Si— are as defined and described above with respect to the same moieties of the siloxane cationic surfactant (b). More specifically, R is H or an unsubstituted C₁-C₄ hydrocarbyl group, D⁵ is the divalent linking group, and each R³ is generally selected from R² and —OSi(R⁴)₃, with the proviso that at least one R³ is —OSi(R⁴)₃, where each R⁴ is independently selected from R², —OSi(R⁵)₃, and —[OSiR²₂]ₘOSiR²₃, wherein each R⁵ is independently selected from R², —OSi(R⁶)₃, and —[OSiR²₂]ₘOSiR²₃, and where each R⁶ is independently selected from R² and —[OSiR²₂]ₘOSiR²₃. In each instance, each R² is an independently selected substituted or unsubstituted hydrocarbyl group, and each subscript m is individually selected such that 0≤m≤100. Notwithstanding the above, one of skill in the art will readily understand the particular variations of limitations of the branched organosilicon moiety (R³)₃Si— in view of the description of the same moiety in the cationic surfactant above.

Alternatively, siloxane moiety Z¹ in the general formula for the amino-functional polyorganosiloxane (a) above is the branched organosilicon moiety and divalent linking group D⁵ is an amino substituted hydrocarbon having formula -D²-NH-D²-, such that the amine compound (A) has the formula (R³)₃Si-D²-NH-D²-NHR, where each D² is an independently selected divalent linking group and each R and R³ are as defined above.

Alternatively, the amino-functional polyorganosiloxane (a) may have the following formula:

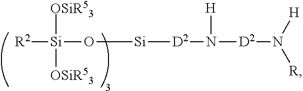

where each R, R², R⁵, and D² are independently selected and defined above. Alternatively, each R⁵ is R², and each R² is methyl. Alternatively, each R is H.

Alternatively, the amino-functional polyorganosiloxane (a) may have the following structure:

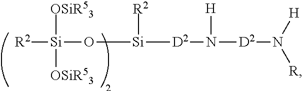

where each R, R², R⁵, and D² are independently selected and defined above. Alternatively, each R⁵ is R², and each R² is methyl. Alternatively, each R is H.

Alternatively, the amino-functional polyorganosiloxane (a) may have the following structure:

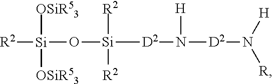

where each R, R², R⁵, and D² are independently selected and defined above. In certain such embodiments, each R⁵ is R², and each R² is methyl. In some such embodiments, each R is H.

In the exemplary structures set forth above pertaining to the siloxane moiety Z¹ being the branched organosilicon moiety, each R⁵ may be R² and each R² may be methyl. However, it is to be appreciated that further generational branching can be introduced into the branched organosilicon moiety when R⁵ is other than R², i.e., when R⁵ is selected from OSi(R⁶)₃ and —[OSiR²₂]ₘOSiR²₃, where each R⁶ is selected from R² and —[OSiR²₂]ₘOSiR²₃ and each R² and subscript m is independently selected and as defined above.

Alternatively, the amino-functional polyorganosiloxane (a) may be a bis-aminofunctional polyorganosiloxane of formula HRN-D⁵-Z¹-D⁵NHR, where R, D⁵, and Z¹ are as described above, e.g., to prepare the siloxane cationic surfactant of formula (b-II) described above. The bis-aminofunctional polyorganosiloxane may be a bis-aminofunctional-terminated polydiorganosiloxane of formula: HRN-D⁵-(R²₂SiO)ⱼⱼSi(R²₂)-D⁵-NR, where R, D⁵, R², and subscript jj are as described above with respect to siloxane cationic surfactant of formula (b-II). Alternatively, the bis-aminofunctional-terminated polydiorganosiloxane may be an aminopropyl-terminated polydimethylsiloxane. Suitable aminopropyl-terminated polydiorganosiloxanes are known in the art and may be made by known methods, such as those disclosed in U.S. Pat. No. 7,238,768 to Hupfield, et al.; U.S. Pat. No. 11,028,229 to Suthiwangcharoen, et al.; and U.S. Pat. No. 11,028,233 to Suthiwangcharoen, et al.

As will be understood by one of skill in the art in view of the description herein, the amino-functional polyorganosiloxane (a) utilized in the preparation method forms a portion of the cationic surfactant corresponding to the amino moiety represented by subformula Z¹(-D⁵-NHR)ₐ, Z-D⁵-N(R)— in formulas (b-I and b-II). Likewise, the quaternary ammonium compound (b) utilized in the preparation method forms a portion of the cationic surfactant corresponding to the quaternary ammonium moiety represented by subformula —NR¹₃+ in formulas (b-I and b-II). As described in additional detail below, the linking group D¹ is generally formed by the reaction of the amino-functional polyorganosiloxane (a) and the quaternary ammonium compound (b), subscript a is controlled by the nature/type of the amino-functional polyorganosiloxane (a) and relative amounts of the amino-functional polyorganosiloxane (a) and the quaternary ammonium compound (b) utilized, and anion X is controlled by the nature/type of the quaternary ammonium compound (b) utilized. As such, it is to be appreciated that the description of the siloxane cationic surfactant above applies equally to the preparation method (e.g. to the starting materials thereof), unless indicated otherwise.

In the preparation method, starting material (b) is the quaternary ammonium compound, which has formula: [R⁹NR¹₃]⁺[X]⁻, where R⁹ is an amine-reactive group; each R¹ is the independently selected unsubstituted hydrocarbyl group having from 1 to 4 carbon atoms as described above; and X is the anion as described above with respect to the siloxane cationic surfactant (b).

The amine-reactive group R⁹ is not particularly limited, and may comprise any group suitable for preparing the siloxane cationic surfactant (b) from the amino-functional polyorganosiloxane (a) and the quaternary ammonium compound (b). More specifically, R⁹ is a group capable of reacting with the alkylatable amine of the amino-functional polyorganosiloxane (a) (e.g. in a coupling reaction) to form a covalent bond between the quaternary ammonium compound (b) and the amino-functional polyorganosiloxane (a). In particular, as will be understood by those of skill in the art in view of the description herein, the amine-reactive group R⁹ forms linking group D¹ of the siloxane cationic surfactant. The coupling reaction of the amino-functional polyorganosiloxane (a) and the quaternary ammonium compound (b) may be classified, characterized, or otherwise described based on the particular selected of the amine-reactive group R⁹, and likewise the reaction of the alkylatable amine of the amino-functional polyorganosiloxane (a) therewith. Examples of suitable coupling reactions include nucleophilic substitutions, ring-opening additions, condensations, nucleophilic additions (e.g. Michael additions), alkylations, and the like, as well as combinations thereof. One of skill in the art will readily appreciate that such coupling reactions may overlap in scope, such that different coupling reactions may be similarly classified/characterized.

Accordingly, the amine-reactive group R⁹ may comprise, alternatively may be, a functional group that is condensable (e.g. a hydroxyl group, a carboxyl group, or an anhydride group), or a group that is hydrolyzable and then subsequently condensable), displaceable (e.g. a “leaving group” as understood in the art, such as a halogen atom, or other group stable in an ionic form once displaced, or a functional group comprising such a leaving group, such as esters, anhydrides, amides, or epoxides), electrophilic (e.g. isocyanates or epoxides), or combinations thereof. Alternatively, the amine-reactive group R⁹ may comprise an epoxide group or a halogen atom, alternatively an epoxy group.

Alternatively, the amine-reactive group R⁹ in the formula for the quaternary ammonium compound (b) is an epoxide-functional group having the formula CH(O)CH-D⁴-, such that the tetra(organo)ammonium cation moiety of the quaternary ammonium compound (b) has the formula:

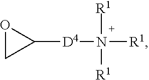

where each R¹ is independently selected and as defined above, and D⁴ is a divalent linking group.

In general, D⁴ is selected from divalent substituted or unsubstituted hydrocarbon groups, which may optionally be modified or substituted, e.g. with alkoxy, siloxy, silyl, amino, amido, acetoxy, and aminoxy groups. D⁴ may be linear or branched. In some embodiments, D⁴ is a C₁-C₂₀ hydrocarbon group. However, D⁴ may be a hydrocarbon group comprising a backbone having at least one heteroatom (e.g. O, N, or S, alternatively O or N). For example, D⁴ may be a hydrocarbon having a backbone comprising an ether moiety. Alternatively, D⁴ may be selected such that the amine-reactive group R⁹ comprises a glycidyl ether. Alternatively, D⁴ may be an alkylene group, such as methylene or ethylene. Alternatively, D⁴ may be methylene, such that the amine-reactive group R⁹ is an epoxypropyl group.

Alternatively, the tetra(organo)ammonium cation moiety of the quaternary ammonium compound (b) may have the formula:

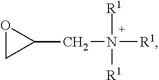

where each R¹ is independently selected and as defined above; alternatively, each R¹ may be methyl.

Alternatively, the amine-reactive group R⁹ in the general formula for the quaternary ammonium compound (b) may be a haloalkyl group having the formula X′″-D⁴-, where D⁴ is as defined above, and X′″ is chlorine or bromine. For example, the amine-reactive group R⁹ may comprise, alternatively may be, a haloethyl group, a halopropyl group, a halobutyl group, a halopentyl group, a halohexyl group, a haloheptyl group, or a halooctyl group, such as the chloro or bromo versions of such groups (e.g. 5-bromopentyl or 2-chloroethyl, 2-bromoethyl), as well as substituted derivatives thereof (e.g. 3-chloro-2-hydroxypropyl).

Specific examples of compounds suitable for use as the quaternary ammonium compound (b) include glycidyltrimethylammonium chloride, (3-chloro-2-hydroxypropyl)trimethylammonium chloride, (5-bromopentyl)trimethylammonium bromide, (2-bromoethyl)trimethylammonium bromide, (2-chloroethyl)trimethylammonium chloride, and combinations thereof (alternatively salt forms, alternatively halo-forms (e.g. bromo vs. chloro, chloro vs. bromo) are also contemplated). Alternatively, other compounds may also be utilized in or as the quaternary ammonium compound (b), such as (3-carboxypropyl)trimethylammonium chloride, [3-(methacryloylamino)propyl]trimethylammonium chloride, [2-(acryloyloxy)ethyl]trimethylammonium chloride, and combinations thereof.

The quaternary ammonium compound (b) may be utilized in any amount, which will be selected by one of skill in the art, depending on various factors, including the particular amine-functional polyorganosiloxane (a) and the quaternary ammonium compound (b) selected for reacting, the reaction parameters employed, the scale of the reaction (e.g. total amounts of quaternary ammonium compound (b) to be reacted, and/or siloxane cationic surfactant to be prepared).

The quaternary ammonium compound (b) may be prepared as part of the preparation method, or otherwise obtained (i.e., as a prepared compound). Methods of preparing compounds suitable for use in, or as, the quaternary ammonium compound (b) are known in the art, and some of such compounds are commercially available from various suppliers. Additionally, preparing the quaternary ammonium compound (b), when part of the preparation method, may be performed prior to the reaction of the amino-functional polyorganosiloxane (a) and the quaternary ammonium compound (b), or in situ (i.e., during the reaction of (a) and (b), such that (b) is consumed upon formation, e.g. via combining components of the quaternary ammonium compound (b) with the amino-functional polyorganosiloxane (a) and, optionally, (c) a catalyst).

Each of components (a) and (b) may be obtained or formed. More specifically, as introduced above, each of the amino-functional polyorganosiloxane (a), quaternary ammonium compound (b) may be provided “as is”, i.e., ready for the reaction to prepare the cationic surfactant. Alternatively, either or both of components (a) and (b) may be formed prior to or during the reaction. As such, in some embodiments, the preparation method comprises preparing the amino-functional polyorganosiloxane (a) and/or the quaternary ammonium compound (b). In specific embodiments, the preparation method comprises preparing the amino-functional polyorganosiloxane (a).

Each of the amino-functional polyorganosiloxane (a) and the quaternary ammonium compound (b) may be utilized in any form, such as neat (i.e., absent carrier vehicles such as solvents, and/or diluents), or disposed in a carrier vehicle. For example, the reaction of the amino-functional polyorganosiloxane (a) and the quaternary ammonium compound (b) may be carried out in the presence of a carrier vehicle (e.g. a solvent, diluent, and/or dispersant). The carrier vehicle may comprise, alternatively may be, a solvent, a fluid, an oil (e.g. an organic oil and/or a silicone oil), or a combination thereof. A carrier vehicle as described above for starting material (d) is suitable for use in the preparation method. Alternatively, a water immiscible solvent or fluid may be used.

When utilized, the carrier vehicle will be selected based on various factors including the particular amino-functional polyorganosiloxane (a) and quaternary ammonium compound (b) selected, in view of a desired coupling reaction thereof. Alternatively, the carrier vehicle may be selected based on the nature and type of amine-reactive group R⁹ in and/or the type of coupling reaction involving the same. For example, the preparation method may be carried out in the presence of a carrier vehicle comprising a polar component, such as water, an alcohol, ether, acetonitrile, dimethylformamide, dimethylsulfoxide, or combinations thereof. Likewise, it will be appreciated that portions of carrier vehicle may be added to or otherwise combined with the amino-functional polyorganosiloxane (a) and quaternary ammonium compound (b), and/or other components (if/when utilized) discretely, collectively with mixtures of components, or with the reaction mixture as a whole. Likewise, the amino-functional polyorganosiloxane (a) and/or quaternary ammonium compound (b) may be combined with the carrier vehicle, if utilized, prior to, during, or after being combined with any one or more other components of the reaction mixture. The total amount of carrier vehicle/solvent present in the reaction mixture will be selected by one of skill in the art, e.g. based on various factors including the particular component selected and the reaction parameters employed.

Alternatively, the amino-functional polyorganosiloxane (a) and the quaternary ammonium compound (b) may be free from, alternatively substantially free from carrier vehicles. In some such embodiments, the amino-functional polyorganosiloxane (a) and the quaternary ammonium compound (b) may be free from, alternatively substantially free from, carrier vehicles/volatiles reactive with the amino-functional polyorganosiloxane (a), the quaternary ammonium compound (b), the siloxane cationic surfactant being prepared, and/or any one or more other components of the reaction mixture. For example, the preparation method may comprise removing volatiles and/or solvents from the amino-functional polyorganosiloxane (a) and the quaternary ammonium compound (b) prior to combining the same with any one or more other components of the reaction mixture. Techniques for removing volatiles are known in the art, and may include stripping and/or distillation with heating, drying, applying reduced pressure/vacuum, azeotroping with solvents, and adsorption utilizing, e.g., molecular sieves, and combinations thereof. Alternatively, the reaction of the amino-functional polyorganosiloxane (a) and the quaternary ammonium compound (b) may be carried out in the absence of any carrier vehicle or solvent, i.e., such that no carrier vehicle or solvent is present in the reaction mixture during the reaction (e.g. the reaction mixture is free from, alternatively substantially free from, solvents). The above notwithstanding, one or both of the amino-functional polyorganosiloxane (a) and the quaternary ammonium compound (b) may be a carrier, e.g. when utilized as a fluid in an amount sufficient to carry, dissolve, or disperse any other component of the reaction mixture.

The relative amounts of the amino-functional polyorganosiloxane (a) and the quaternary ammonium compound (b) utilized may vary, e.g. based upon the particular the amino-functional polyorganosiloxane (a), particular the quaternary ammonium compound (b) selected, and the reaction parameters employed, e.g. whether a catalyst or other component is utilized. Typically, an excess (e.g. molar and/or stoichiometric) of one of the amino-functional polyorganosiloxane (a) and the quaternary ammonium compound (b) is utilized to fully transform or consume the amino-functional polyorganosiloxane (a) or the quaternary ammonium compound (b), e.g. to simplify purification of the reaction product formed therefrom. For example, in certain embodiments, the quaternary ammonium compound (b) is utilized in relative excess of the amino-functional polyorganosiloxane (a) to maximize alkylation of the amino-functional polyorganosiloxane (a) to prepare the siloxane cationic surfactant therefrom. It will be appreciated that the amino-functional polyorganosiloxane (a) may instead be used in excess of the quaternary ammonium compound (b) (e.g. when maximum consumption of the quaternary ammonium compound (b) is desired, and/or limited alkylation of the amino-functional polyorganosiloxane (a) is desired).

As understood by those of skill in the art, the alkylation/coupling of the amino-functional polyorganosiloxane (a) with the quaternary ammonium compound (b) occurs at a theoretical maximum based on the number alkylatable amino groups (e.g. N—H groups) within the amino-functional polyorganosiloxane (a). In particular, with reference to the general formula of the amino-functional polyorganosiloxane (a) above, the amine moiety of formula —NHR can be alkylated once when R is the unsubstituted hydrocarbyl group, and twice when R is H. Moreover, when the divalent linking group D⁵ is the amino substituted hydrocarbon moiety of formula -D²-NH-D²-, the amino-functional polyorganosiloxane (a) comprises another alkylatable amino group. As such, the amino-functional polyorganosiloxane (a) may comprise one, alternatively two, alternatively three alkylatable amino groups depending on the selection of R and the divalent linking group D⁵. Each of these alkylatable amino groups can be reacted with one of the amine-reactive group R⁹, such that that one molar equivalent of the quaternary ammonium compound (b) is needed for every alkylatable amino group of the amino-functional polyorganosiloxane (a) to achieve a theoretically complete (i.e., maximum) alkylation reaction. Likewise, the theoretical maximum stoichiometric ratio of the reaction of the amino-functional polyorganosiloxane (a) with the quaternary ammonium compound (b) is 1:1 [N—H]:[R⁹], where [N—H] represents the number of alkylatable amino groups of the amino-functional polyorganosiloxane (a) and [R⁹] represents the number of amine-reactive groups R⁹ of the quaternary ammonium compound (b), which is generally fixed at 1. As such, the amino-functional polyorganosiloxane (a) and the quaternary ammonium compound (b) are typically reacted in a stoichiometric ratio of 10:1 to 1:10, alternatively 8:1 to 1:8, alternatively 6:1 to 1:6, alternatively 4:1 to 1:4, alternatively 2:1 to 1:2, alternatively 1:1 [N—H]:[R⁹], where [N—H] and [R⁹] are as defined above. Alternatively, the amino-functional polyorganosiloxane (a) and the quaternary ammonium compound (b) are reacted in a molar ratio of 10:1 to 1:10, alternatively 8:1 to 1:8, alternatively 6:1 to 1:6, alternatively 4:1 to 1:4, alternatively 2:1 to 1:2, alternatively 1:1.5, (a):(b).

It will be appreciated, however, that ratios outside of the specific ranges above may also be utilized. For example, the quaternary ammonium compound (b) may be utilized in a gross excess (e.g. in an amount of ≥5, alternatively ≥10, alternatively ≥15, alternatively ≥20, times the stoichiometric or molar amount of the amino-functional polyorganosiloxane (a)), such as when the quaternary ammonium compound (b) is utilized as a carrier (i.e., a solvent or diluent) during the reaction. Alternatively, the amino-functional polyorganosiloxane (a) may be utilized in a gross excess (e.g. in an amount of ≥5, alternatively ≥10, alternatively ≥15, alternatively >20, times the stoichiometric or molar amount of the quaternary ammonium compound (b)), such as when the amino-functional polyorganosiloxane (a) is utilized as a carrier (i.e., a solvent or diluent) during the reaction. Regardless, one of skill in the art will readily select the particular amounts and ratios of the various components to prepare the siloxane cationic surfactants as described herein, including the theoretical maximum reactivity ratios described above, the presence of any carrier vehicle, and the particular components utilized.

Alternatively, the preparation method may comprise reacting the amino-functional polyorganosiloxane (a) and the quaternary ammonium compound (b) in the presence of (c) a catalyst. The inclusion of the catalyst (c) is typically based on the selection of the amine-reactive group R⁹ of the quaternary ammonium compound (b). Likewise, the particular type or specific compound selected for use in or as the catalyst (c), will be readily selected by those of skill in the art based on the particular amino-functional polyorganosiloxane (a) and the quaternary ammonium compound (b) selected. More specifically, the catalyst (c) is selected to catalyze the coupling of the amino-functional polyorganosiloxane (a) with the quaternary ammonium compound (b), and thus will be selected based on the particular amine-reactive group R⁹ of the quaternary ammonium compound (b) utilized and the type of coupling reaction desired. As such, the catalyst (c) is not particularly limited, and may comprise or be any compound suitable for facilitating the coupling of the amino-functional polyorganosiloxane (a) with the quaternary ammonium compound (b) (e.g. via reaction of/including the alkylatable amine of the amino-functional polyorganosiloxane (a) and amine-reactive group R⁹ of the quaternary ammonium compound (b)), as will be understood by one of skill in the art in view of the description herein. For example, the catalyst (c) may be selected from those facilitating reactions including ring-opening addition, nucleophilic substitution, nucleophilic additions, alkylation, condensation, and combinations of such reactions.

Alternatively, the catalyst (c) may comprise, alternatively may be, an acid or base catalyst, such as an inorganic or organic base or acid (i.e., an acid-type or base-type catalyst), a Lewis acid or Lewis base. Alternatively, the catalyst (c) may comprise metal atoms, alternatively may be substantially free from, alternatively may be free from metal atoms. As understood by those of skill in the art, acid/base-type catalysts may be utilized to couple the amino-functional polyorganosiloxane (a) and the quaternary ammonium compound (b) via ring opening reaction, nucleophilic substitution, nucleophilic addition, or condensation.

Examples of acid/base-type catalysts suitable for use in or as the catalyst (c) include lithium hydroxide (LiOH), sodium hydroxide (NaOH), potassium hydroxide (KOH), cesium hydroxide (CsOH), tetramethylammonium hydroxide ((CH₃)₄NOH), 1,8-diazabicyclo [5.4.0]undec-7-ene (DBU), sulfonic acids, sulfuric acid (H₂SO₄), carboxylic acids, mineral acids, and combinations thereof. Alternatively, the catalyst (c) may comprise, alternatively may be, a mineral acid, such as hydrochloric acid (HCl), nitric acid (HNO₃), phosphoric acid (H₃PO₄), sulfuric acid (H₂SO₄), boric acid (H₃BO₃), hydrofluoric acid (HF), hydrobromic acid (HBr), perchloric acid (HClO₄), or combinations thereof. Alternatively, the mineral acid may be selected based on the anion X (or X′). For example, in certain embodiments anion is Cl⁻, and the catalyst (c) comprises, alternatively is, hydrochloric acid.

Methods of preparing compounds suitable for use in, or as, the catalyst (c) are well known in the art, and many of the compounds listed herein are commercially available from various suppliers. As such, the catalyst (c) may be prepared as part of the preparation method, or otherwise obtained (i.e., as a prepared compound). Additionally, preparing the catalyst (c) may be performed prior to the reaction of the amino-functional polyorganosiloxane (a) and the quaternary ammonium compound (b), or in situ (i.e., during the reaction of (a) and (b), e.g. via combining components of the catalyst (c) with (a) and/or (b)).

The catalyst (c) may be utilized in any form, such as neat (i.e., absent carrier vehicles such as solvents or diluents), or disposed in a carrier vehicle, such as a solvent or diluent (e.g. such as any of those listed above). Alternatively, the catalyst (c) may be utilized in a form absent water and/or carrier vehicles/volatiles reactive with the amino-functional polyorganosiloxane (a) and the quaternary ammonium compound (b), the catalyst (c) itself (i.e., at least until combined with (a) and (b)), and/or the siloxane cationic surfactant being prepared. For example, the preparation method may comprise removing volatiles and/or solvents (e.g. water or organic solvent) from the catalyst (c). Techniques for removing volatiles are known in the art, and may include heating, drying, applying reduced pressure/vacuum, azeotroping with solvents, adsorption utilizing molecular sieves, and combinations thereof. Alternatively, the catalyst (c) may be utilized as a solution or suspension in a carrier vehicle. For example, the catalyst (c) may comprise an aqueous solution of a mineral acid, such as HCl (aq.).

The catalyst (c) may be utilized in any amount, which will be selected by one of skill in the art, e.g. dependent upon the particular catalyst (c) selected (e.g. the concentration/amount of active components thereof, the type of catalyst being utilized, and the type of coupling reaction being performed), the reaction parameters employed, the scale of the reaction (e.g. total amounts of couple the amino-functional polyorganosiloxane (a) and the quaternary ammonium compound (b). The molar ratio of the catalyst (c) to couple the amino-functional polyorganosiloxane (a) and/or the quaternary ammonium compound (b) utilized in the reaction may influence the rate and/or amount of coupling thereof to prepare the siloxane cationic surfactant. Thus, the amount of the catalyst (c) as compared to couple the amino-functional polyorganosiloxane (a) and/or the quaternary ammonium compound (b), as well as the molar ratios therebetween, may vary. Typically, these relative amounts and the molar ratio are selected to maximize the reaction of (a) and (b) while minimizing the loading of the catalyst (c) (e.g. for increased economic efficiency of the reaction, and/or increased ease of purification of the reaction product formed). However, the catalyst (c) may be utilized in an amount of 0.000001 to 50%, based on the total amount of couple the amino-functional polyorganosiloxane (a) utilized (i.e., wt./wt.). For example, the catalyst (c) may be used in an amount of 0.000001 to 40%, alternatively 0.000001 to 20%, alternatively 0.000001 to 10%, alternatively 0.000002 to 5%, alternatively 0.000002 to 2%, alternatively 0.000002 to 0.5%, alternatively 0.00001 to 0.5%, alternatively 0.0001 to 0.5%, alternatively 0.001 to 0.5%, and alternatively 0.01 to 0.5%, based on the total amount of couple the amino-functional polyorganosiloxane (a) utilized. Alternatively, the catalyst (c) may be utilized in the reaction in an amount of 0.000001 to 50%, based on the total amount of couple the quaternary ammonium compound (b) utilized (i.e., wt./wt.). For example, the catalyst (c) may be used in an amount of 0.000001 to 40%, alternatively 0.000001 to 20%, alternatively 0.000001 to 10%, alternatively 0.000002 to 5%, alternatively 0.000002 to 2%, alternatively 0.000002 to 0.5%, alternatively 0.00001 to 0.5%, alternatively 0.0001 to 0.5%, alternatively 0.001 to 0.5%, alternatively 0.01 to 0.5%, based on the total amount of the quaternary ammonium compound (b) utilized. It will be appreciated that ratios outside of these ranges may be utilized as well.

Alternatively, (e.g. when the type of crosslinking reaction dictates a stoichiometric loading), the amount of the catalyst (c) utilized may be selected and/or determined on a molar ratio based on one or more components of the reaction, as will be understood by those of skill in the art. The catalyst (c) may be utilized in the reaction mixture in an amount of from 0.001 to 50 mol %, based on the total amount of the amino-functional polyorganosiloxane (a), or the quaternary ammonium compound (b), utilized. For example, the catalyst (c) may be used in an amount of 0.005 to 40 mol %, alternatively 0.005 to 30 mol %, alternatively 0.005 to 20 mol %, alternatively 0.01 to 20 mol %, based on the total amount of (a) utilized, the total amount of (b) utilized, or the total (i.e., combined) amount of (a) and (b) utilized. However, it will also be appreciated that ratios outside of these ranges may be utilized.

Reacting the amino-functional polyorganosiloxane (a) and the quaternary ammonium compound (b) generally comprises combining the amino-functional polyorganosiloxane (a) and the quaternary ammonium compound (b). Said differently, there is generally no proactive step required for the reaction reduction beyond combining (a) and (b), although various optional steps are described herein.

Typically, the amino-functional polyorganosiloxane (a) and the quaternary ammonium compound (b), and optionally (c), are reacted in a reactor to prepare the siloxane cationic surfactant. When the reaction is carried out at an elevated or reduced temperature as described below, the reactor may be heated or cooled in any suitable manner, e.g. via a jacket, mantle, exchanger, bath, or coils.

The amino-functional polyorganosiloxane (a) and the quaternary ammonium compound (b), and optionally the catalyst (c), may be fed together or separately to the reactor, or may be disposed in the reactor in any order of addition, and in any combination. For example, (b) and (c) may be added to a reactor containing (a), and (b) and (c) may optionally be first combined prior to the addition, or may be added to the reactor sequentially (e.g. (c) then (b)). Alternatively (c) may be added to a reactor containing (a) and (b), either as a premade catalyst or as individual components to form the catalyst (c) in situ. In general, reference to the “reaction mixture” herein refers generally to a mixture comprising (a), (b), and optionally (c) if utilized, (e.g. as obtained by combining such components, as described above).

The preparation method may further comprise agitating the reaction mixture. The agitating may enhance mixing and contacting together (a), (b), and optionally (c), when combined, e.g. in the reaction mixture thereof. Such contacting independently may use other conditions, with (e.g. concurrently or sequentially) or without (i.e., independent from, alternatively in place of) the agitating. The other conditions may be tailored to enhance the contacting, and thus reaction, of the amino-functional polyorganosiloxane (a) with the quaternary ammonium compound (b) to form the siloxane cationic surfactant. Other conditions may be result-effective conditions for enhancing reaction yield or minimizing amount of a particular reaction by-product included within the reaction product along with the siloxane cationic surfactant.

The amino-functional polyorganosiloxane (a) and the quaternary ammonium compound (b) may be reacted under homogeneous or heterogeneous conditions, e.g. such as in a homogeneous solution or a multiphase (e.g. biphasic) reaction. The particular form and condition of the reaction of (a) and (b), optionally in the presence of the catalyst (c) are independently selected, as will be appreciated from the examples herein.

Alternatively, depending on the particular quaternary ammonium compound (b) utilized, the reaction of (a) and (b) may produce byproducts. These byproducts may be removed from the reaction mixture once produced. As understood in the art, some of the coupling reactions are reversible reactions, such that removing the byproducts from the reaction mixture influences the reaction in terms of selectivity in favor, and/or overall yields, of the siloxane cationic surfactant (e.g. by selectively driving the equilibrium of the reaction toward that product). Removing the byproducts may include distillation, heating, applying reduced pressure/vacuum, azeotroping with solvents, adsorption, e.g., utilizing molecular sieves, and combinations thereof, even during the reaction.

Alternatively, the reaction may be carried out at an elevated temperature. The elevated temperature will be selected and controlled depending on various factors including the particular amino-functional polyorganosiloxane (a) selected, the particular quaternary ammonium compound (b) selected, and the reactor selected (e.g. whether open to ambient pressure, sealed, or under reduced pressure). Accordingly, the elevated temperature will be readily selected by one of skill in the art in view of the reaction conditions and parameters selected and the description herein. However, the elevated temperature may be greater than 25° C.(ambient temperature) to 300° C., alternatively 30 to 260, alternatively 30 to 250, alternatively 35 to 250, alternatively 35 to 225, alternatively 35 to 200, alternatively 40 to 200, alternatively 40 to 180, alternatively 40 to 160, alternatively 45 to 140, alternatively 45 to 120, alternatively 40 to 120° C.

It is to be appreciated that the elevated temperature may differ from the ranges set forth above, especially when both elevated temperature and another condition (e.g. reduced pressure) are utilized in combination. Likewise, it is also to be appreciated that reaction parameters may be modified during the reaction of (a) and (b). For example, temperature, pressure, and other parameters may be independently selected or modified during the reaction. Any of these parameters may independently be an ambient parameter (e.g. room temperature and/or atmospheric pressure) and/or a non-ambient parameter (e.g. reduced or elevated temperature and/or reduced or elevated pressure). Any parameter, may also be dynamically modified, modified in real time, i.e., during the reaction, or may be static (e.g. for the duration of the reaction, or for any portion thereof).

The time during which the reaction of (a) and (b) to prepare the siloxane cationic surfactant is carried out is a function of various factors including scale, reaction parameters and conditions, and selection of particular components. On a relatively large scale (e.g. greater than 1, alternatively 5, alternatively 10, alternatively 50, alternatively 100 kg), the reaction may be carried out for hours, such as 2 to 240, alternatively 2 to 120, alternatively 2 to 96, alternatively 2 to 72, alternatively 2 to 48, alternatively 3 to 36, alternatively 4 to 24, alternatively of 6, 12, 18, 24, 36, or 48 hours, as will be readily determined by one of skill in the art (e.g. by monitoring conversion of the amino-functional polyorganosiloxane (a) or production of the siloxane cationic surfactant, such as via chromatographic and/or spectroscopic methods). In certain embodiments, the time during which the reaction is carried out is greater than 0 to 240 hours, alternatively 1 to 120 hours, alternatively 1 to 96 hours, alternatively 1 to 72 hours, alternatively 1 to 48 hours, alternatively 1 to 36 hours, alternatively 1 to 24 hours, alternatively 1 to 12 hours, alternatively 2 to 12 hours, alternatively 2 to 8 hours, after (a) and (b) are combined, optionally in the presence of the catalyst (c). In specific embodiments, the time during which the reaction is carried out is from greater than 0 to 10 hours, such as from 1 minute to 8 hours, alternatively 5 minutes to 6 hours, alternatively 10 minutes to 4 hours, alternatively 30 minutes to 3 hours.

Generally, the reaction of the amino-functional polyorganosiloxane (a) and the quaternary ammonium compound (b) prepares a reaction product comprising the siloxane cationic surfactant. In particular, over the course of the reaction, the reaction mixture comprising (a) and (b) comprises increasing amounts of the siloxane cationic surfactant and decreasing amounts of (a) and (b). Once the reaction is complete (e.g. one of (a) and (b) is consumed, and/or no additional siloxane cationic surfactant is being prepared), the reaction mixture may be referred to as a reaction product comprising the siloxane cationic surfactant. In this fashion, the reaction product typically includes any remaining amounts of (a) and (b), and optionally (c), as well as degradation and/or reaction products thereof (e.g. byproducts and/or other materials which were not previously removed via any distillation, stripping, and/or adsorption). If the reaction is carried out in any carrier vehicle, the reaction product may also include such carrier vehicle.

Alternatively, the preparation method may optionally further comprise adjusting the pH of the reaction product. As will be understood by those of skill in the art, adjusting the pH of the reaction product comprises adding an acid or base thereto to increase or decrease the pH, respectively. For example, adjusting the pH may comprise adding an acid (e.g. HCl) in an amount sufficient to adjust the pH of the reaction product to ≥8, alternatively ≥9. Alternatively, the preparation method comprises adding the acid in an amount sufficient to protonate some, but not all, amine groups of the siloxane cationic surfactant, such that the reaction product is prepared as a buffered solution (i.e., with both free-amine groups as well as protonated forms (e.g. ammonium cations) thereof).

Alternatively, the preparation method may further comprise isolating and/or purifying the siloxane cationic surfactant from the reaction product. As used herein, isolating the siloxane cationic surfactant is typically defined as increasing the relative concentration of the siloxane cationic surfactant as compared to other compounds in combination therewith (e.g. in the reaction product or a purified version thereof). As such, as is understood in the art, isolating/purifying may comprise removing the other compounds from such a combination (i.e., decreasing the amount of impurities combined with the siloxane cationic surfactant, e.g. in the reaction product) and/or removing the siloxane cationic surfactant itself from the combination. Any suitable technique and/or protocol for isolation may be utilized. Examples of suitable isolation techniques include distilling, stripping/evaporating, extracting, filtering, washing, partitioning, phase separating, chromatography, adsorption, and a combination thereof. As will be understood by those of skill in the art, any of these techniques may be used in combination (i.e., sequentially) with any another technique to isolate the siloxane cationic surfactant. It is to be appreciated that isolating may include, and thus may be referred to as, purifying the siloxane cationic surfactant. However, purifying the cationic surfactant may comprise alternative and/or additional techniques as compared to those utilized in isolating the siloxane cationic surfactant. Regardless of the particular technique(s) selected, isolation and/or purification of siloxane cationic surfactant may be performed in sequence (i.e., in line) with the reaction itself, and thus may be automated. In other instances, purification may be a stand-alone procedure to which the reaction product comprising the siloxane cationic surfactant is subjected.

Alternatively, isolating the siloxane cationic surfactant may comprise altering the solubility profile of the carrier vehicle, e.g. by adding additional organic or aqueous solvent thereto, e.g. to partition and/or phase separate the reaction product. Alternatively, isolating the siloxane cationic surfactant may comprise filtering away other components of the reaction product (i.e., where the siloxane cationic surfactant is present in a residue/solid. Alternatively, isolating the siloxane cationic surfactant may comprise washing away other components of the reaction product from the siloxane cationic surfactant (e.g. with organic and/or aqueous solvents). Alternatively, isolating the siloxane cationic surfactant may comprise stripping solvents and/or other volatile components therefrom, which encompasses drying the siloxane cationic surfactant b).

The amount of the siloxane cationic surfactant b), prepared as described above, used in the foam stabilizing composition, depends on various factors including the form of the composition prepared, a desired use thereof, and other starting materials present therein. For example, one of skill in the art will appreciate that, when the composition is formulated as a concentrate, the siloxane cationic surfactant b) will be present in higher relative amounts as compared to non-concentrated forms. As such, the siloxane cationic surfactant b) may be present in the foam stabilizing composition in an amount sufficient to provide a weight ratio of colloidal silica : siloxane cationic surfactant i.e., a):b) weight ratio (wt:wt) of 1:10⁻⁴ to 1:1, alternatively 1:10⁻⁴ to 1:0.1, when starting material c), the organic cationic surfactant, is not present. Alternatively, starting material b) and c), i.e. a:(b+c) is 1:10⁻⁴ to 1:1, alternatively 1:10⁻⁴ to 1:0.1.

### c) Organic Cationic Surfactant

As introduced above, starting material c) is an optional organic cationic surfactant, i.e., a complex comprising a cationic quaternary organoammonium compound charge-balanced with a counter ion. The organic cationic surfactant c) comprises a hydrocarbon moiety and one or more quaternary ammonium moieties, and conforms to general formula (c-I): [Z²-D²-N(Y′)_{b}(R)_{2-b}]^{+y} [X^{-x}]ₙ, where Z² is an unsubstituted hydrocarbyl group; D² is a covalent bond or a divalent linking group; subscript b is 1 or 2; and each R, Y, superscript y, X, subscript n, and superscript x is independently selected and as defined above.

With regard to the organic cationic surfactant c) and formula (c-I), each R, Y′, superscript y, X, subscript n, and superscript x is independently selected and as defined above with respect to the siloxane cationic surfactant b). As such, while specific selections are exemplified below with regard to these variables in formula (c-I) representing the organic cationic surfactant c), it will be appreciated that such selections are not limiting, but rather that all description of R, Y′, superscript y, X, subscript n, and superscript x, as well as variables thereof (e.g. divalent linking group D of quaternary ammonium moieties Y′, groups D′ and subscripts e of divalent linking groups D).

In formula (c-I), Z² is an unsubstituted hydrocarbyl group, and is otherwise not particularly limited. Examples of suitable such hydrocarbyl groups include the unsubstituted monovalent hydrocarbon moieties described above with respect to R^{x}. As such, it will be appreciated that the hydrocarbyl group Z² may comprise, alternatively may be, linear, branched, cyclic, or combinations thereof. Likewise, the hydrocarbyl group Z² may comprise aliphatic unsaturation, including ethylenic and/or acetylenic unsaturation (i.e., C—C double and/or triple bonds, otherwise known as alkenes and alkynes, respectively). The hydrocarbyl group Z² may comprise but one such unsaturated group or, alternatively, may comprise more than one unsaturated group, which may be nonconjugated, or conjugated (e.g. when the hydrocarbyl group Z² comprises, e.g. a diene, an ene-yne, or a diyne) and/or aromatic (e.g. when the hydrocarbyl group Z² comprises, e.g., a phenyl group or a benzyl group).

Alternatively, the hydrocarbyl group Z² may be an unsubstituted hydrocarbyl moiety having from 3 to 18 carbon atoms. Alternatively, the hydrocarbyl group Z² may comprise, alternatively the hydrocarbyl group Z² may be, an alkyl group. Suitable alkyl groups include saturated alkyl groups, which may be linear, branched, cyclic (e.g. monocyclic or polycyclic), or combinations thereof. Examples of such alkyl groups include those having the general formula C_{f}H_{2f-2g+1}, where subscript f is from 5 to 20 (i.e., the number of carbon atoms present in the alkyl group), subscript g is the number of independent rings/cyclic loops, and at least one carbon atom designated by subscript f is bonded to group D² in general formula (c-I) above. Examples of linear and branched isomers of such alkyl groups (i.e., where the alkyl group is free from cyclic groups such that subscript f=0), include those having the general formula C_{f}H_{2f+1}, where subscript f is as defined above and at least one carbon atom designated by subscript f is bonded to group D² in general formula (c-I) above. Examples of monocyclic alkyl groups include those having the general formula C_{f}H_{2f-1}, where subscript f is as defined above and at least one carbon atom designated by subscript f is bonded to group D² in general formula (c-I) above.

Specific examples of such alkyl groups include pentyl groups, hexyl groups, heptyl groups, octyl groups, nonyl groups, decyl groups, undecyl groups dodecyl groups, tridecyl groups, tetradecyl groups, pentadecyl groups, hexadecyl groups, heptadecyl groups, octadecyl groups, nonadecyl groups, and eicosyl groups, including linear, branched, and/or cyclic isomers thereof. For example, pentyl groups encompass n-pentyl (i.e., a linear isomer) and cyclopentyl (i.e., a cyclic isomer), as well as branched isomers such as isopentyl (i.e., 3-methylbutyl), neopentyl (i.e., 2,2-dimethylpropyl), tert-pentyl (i.e., 2-methylbutan-2-yl), sec-pentyl (i.e., pentan-2-yl), sec-isopentyl (i.e., 3-methylbutan-2-yl)), 3-pentyl (i.e., pentan-3-yl), and active pentyl (i.e., 2-methylbutyl).

Alternatively, the hydrocarbyl group Z² may comprise, alternatively may be, an unsubstituted linear alkyl group of formula —(CH₂)_{f-1}CH₃, where subscript f is 5 to 20 as described above. Alternatively, the hydrocarbyl group Z² may be such an unsubstituted linear alkyl group, where subscript f is 7 to 19, such that the hydrocarbyl group Z² is an unsubstituted linear alkyl group having from 6 to 18 carbon atoms. Alternatively, subscript b may be 7, 9, 11, or 13, such that the hydrocarbyl group Z² may be an unsubstituted linear alkyl group having 6, 8, 10, or 12 carbon atoms, respectively.

Subscript b is 1 or 2. As will be appreciated by those of skill in the art in view of the description relating to subscript a of the siloxane cationic surfactant b), subscript b indicates whether the quaternary ammonium-substituted amino moiety of the organic cationic surfactant c) represented by subformula —N(Y′)_{b}(R)_{2-b} has one or two of quaternary ammonium groups Y′ (i.e., the group of subformula (-D-NR¹₃+). Likewise, as each such quaternary ammonium groups Y′, subscript b also indicates the number of counter anions (i.e., number of anions X, as described below) required to balance out the cationic charge from the quaternary ammonium groups Y′ indicated by moieties b.

It is to be appreciated that, while subscript b is 1 or 2 in each cationic molecule of the organic cationic surfactant c), the organic cationic surfactant c) may comprise a mixture of cationic molecules that correspond to formula (c-I) but are different from one another (e.g. with respect to subscript b). As such, while subscript b is 1 or 2, a mixture comprising the organic cationic surfactant c) may have an average value of b of from 1 to 2, such as an average value of 1.5 (e.g. from a 50:50 mixture of cationic molecules of the organic cationic surfactant c) where b=1 and molecules of the organic cationic surfactant c) where b=2.

With further regard to the organic cationic surfactant c) and formula (c-I), as introduced above, D² represents a covalent bond or a divalent linking group. For clarity and ease of reference, D² may be referred to more particularly as the “covalent bond D²” or “divalent linking group D²”, e.g. when D² is the covalent bond or the divalent linking group, respectively. Both selections are described and illustrated below.

Alternatively, D² may be the covalent bond (i.e., the organic cationic surfactant c) comprises the covalent bond D²), such that hydrocarbyl moiety Z² is bonded directly to the amino N atom, and the organic cationic surfactant c) may be represented by the following formula: [Z²—N(Y′)_{b}(R)_{2-b}]^{+y} [X^{-x}]ₙ, where each Z², Y′, R, X, subscript b, superscript y, superscript x, and subscript n are as defined and described above. Alternatively, the hydrocarbyl moiety Z² may be an alkyl group bonded directly to the amino N atom of the organic cationic surfactant c), such that the organic cationic surfactant c) has the following formula: [(C_{f}H_{2f+1})—N(Y′)_{b}(R)_{2-b}]^{+y} [X^{-x}]ₙ, where subscript b, subscript f, Y′, R, X, superscript y, superscript x, and subscript n are as defined and described above. Alternatively, subscript f may be 6 to 18, such as 6 to 14, alternatively from 6 to 12.

Alternatively, D² may be the divalent linking group bond (i.e., the organic cationic surfactant c) comprises the divalent linking group D²). The divalent linking group D² is not particularly limited, and is generally selected from the same groups described above with respect to divalent linking group D¹. Accordingly, divalent linking group D² may be selected from divalent hydrocarbon groups. Examples of such hydrocarbon groups include divalent forms of the hydrocarbyl and hydrocarbon groups described above, such as any of those set forth above with respect to R^{x}. As such, it will be appreciated that suitable hydrocarbon groups for the divalent linking group D² may be substituted or unsubstituted, linear, branched, and/or cyclic, and the same or different from any other linking group in the organic cationic surfactant c) and/or the siloxane cationic surfactant b).

Alternatively, divalent linking group D² may comprise, alternatively may be a linear or branched alkyl and/or alkylene group. Alternatively, divalent linking group D² may comprise, alternatively may be, a C₁-C₁₈ hydrocarbon moiety, such as the linear hydrocarbon moiety having the formula —(CH₂)_{d}—, defined above with respect to D¹ (i.e., where subscript d is 1 to 18). Alternatively, subscript d may be 1 to 16, alternatively 1 to 12, alternatively 1 to 10, alternatively 1 to 8, alternatively 1 to 6, alternatively 2 to 6, alternatively 2 to 4. Alternatively, subscript d may be 3, such that divalent linking group D² comprises a propylene (i.e., a chain of 3 carbon atoms). It will also be appreciated that each alkyl and/or alkylene group suitable for D² may independently be unsubstituted and unbranched, or substituted and/or branched. Alternatively, divalent linking group D² may comprise, alternatively may be, an unsubstituted alkylene group. Alternatively, divalent linking group D² may comprise, alternatively may be, a substituted hydrocarbon group, such as a substituted alkylene group. For example, divalent linking group D² may comprise a carbon backbone having at least 2 carbon atoms and at least one heteroatom (e.g. O, N, S, or P), such that the backbone comprises, e.g., an ether moiety or amine moiety.

Alternatively, divalent linking group D² may comprise, alternatively may be, an amino substituted hydrocarbon group (i.e., a hydrocarbon comprising a nitrogen-substituted carbon chain/backbone). For example, the divalent linking group D² may be an amino substituted hydrocarbon having formula -D⁴-N(R⁸)-D⁴-, such that the organic cationic surfactant c) may be represented by the following formula:

[Z²-D⁴-N(R⁸)-D⁴-N(Y′)_{b}(R)_{2-b}]^{+y} [X^{-x}]ₙ, where each D⁴ is an independently selected divalent linking group, R⁸ is Y′ or H, and each Z², Y′, R, subscript b, X, superscript y, superscript x, and subscript n is as defined and described above.

As introduced above, each D⁴ of the amino substituted hydrocarbon divalent linking group is independently selected. Typically, each D⁴ comprises an independently selected alkylene group, such as any of those described above with respect to divalent linking group D³ of the siloxane cationic surfactant b). For example, each D⁴ may be independently selected from alkylene groups having from 1 to 8 carbon atoms, such as from 2 to 8, alternatively from 2 to 6, alternatively from 2 to 4 carbon atoms. Alternatively, each D⁴ may be propylene (i.e., —(CH₂)₃—). However, it is to be appreciated that one or both D⁴ may be, or comprise, another divalent linking group (i.e., aside from the alkylene groups described above). Moreover, each D⁴ may be substituted or unsubstituted, linear or branched, and various combinations thereof.

As also introduced above, R⁸ of the amino substituted hydrocarbon is H or quaternary ammonium moiety Y′ (i.e., of formula -D-NR¹₃+, as set forth above). For example, R⁸ may be H, such that the organic cationic surfactant c) may be represented by the following formula: [Z²-D⁴-NH-D⁴-N(Y′)_{b}(R)_{2-b}]^{+y} [X^{-x}]ₙ, where each Z², D⁴, Y′, R, subscript b, X, superscript y, superscript x, and subscript n is as defined and described above. Alternatively, superscript y may be 1 or 2, controlled by subscript b. More particularly, the number of quaternary ammonium moieties Y′ will be controlled by subscript b as 1 or 2, providing a total cationic charge of +1 or +2, respectively. Accordingly, superscript x will also be 1 or 2, such that the organic cationic surfactant c) will be charge balanced.

Alternatively, R⁸ may be Y′, such that the organic cationic surfactant c) may be represented by the following formula: [Z²-D⁴-NY-D⁴-N(Y′)_{b}(R)_{2-b}]^{+y} [X^{-x}]ₙ, where each Z², D⁴, Y, Y′, R, subscript b, X, superscript y, superscript x, and subscript n is as defined and described above. Alternatively, y=b+1, such that superscript y is 2 or 3. More particularly, the number of quaternary ammonium moieties will include the Y′ of R⁸ as well as the 1 or 2 quaternary ammonium moiety Y′ controlled by subscript b, providing a total cationic charge of +2 or +3, respectively. Accordingly, superscript x will be 1, 2, or 3, such that the organic cationic surfactant c) will be charge balanced. For example, subscript b may be 1 and X may be monoanionic, such that the organic cationic surfactant c) has the following formula:

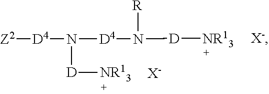

where each Z², D⁴, R, D, R¹, and X is as defined and described above. Alternatively, the organic cationic surfactant c) may be configured as described immediately above, but with b=2, such that the organic cationic surfactant c) has the following formula:

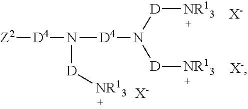

where each Z², D⁴, D, R¹, and X is as defined and described above.

Alternatively, D² may be the covalent bond, Z² may be the linear alkyl group, subscript b may be 1, R may be H, each linking group D may be a (2-hydroxy)propylene group, each R¹ may be methyl, and X may be a monoanion, such that the organic cationic surfactant c) has the following formula:

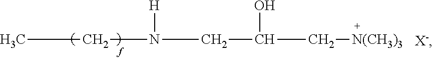

where subscript f is 5 to 17 (e.g. alternatively 5 to 11, alternatively 5 to 9), and X is as defined and described above. Alternatively, the organic cationic surfactant c) may be configured the same as described immediately above, but with subscript b=2, such that the organic cationic surfactant c) has the following formula:

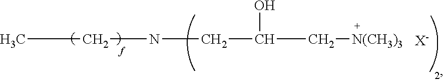

where each X is as defined above and described below.

Alternatively, Z² may be a linear alkyl group having from 3 to 13 carbon atoms, the divalent linking group D² may be the amino substituted hydrocarbon where each D⁴ may be propylene and R⁸ may be H, subscript b may be 1, R may be H, each linking group D may be a (2-hydroxy)propylene group, each R¹ may be methyl, and X may be a monoanion, such that the organic cationic surfactant c) has the following formula:

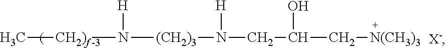

where subscript f and X are as defined and described above. Alternatively, the organic cationic surfactant c) may be configured the same as described immediately above, but with subscript b=2, such that the organic cationic surfactant c) has the following formula:

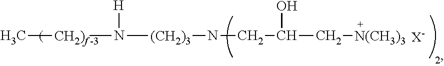

where subscript f and each X are as defined and described above. Alternatively, the organic cationic surfactant c) may be configured the same as described immediately above, but with R⁸ being the quaternary ammonium moiety Y′, such that the organic cationic surfactant c) has the following formula:

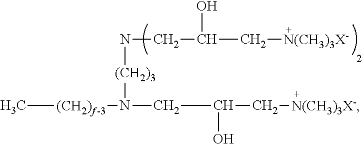

where subscript f and each X are as defined and described above. Alternatively, the organic cationic surfactant c) may be configured the same as described immediately above, but with subscript b=1 and R being H, such that the organic cationic surfactant c) has the following formula:

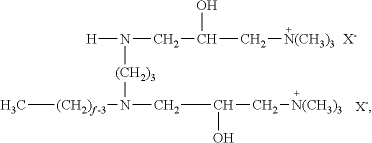

where subscript f and each X are as defined and described above.

Alternatively, each anion X of the organic cationic surfactant c) is an inorganic anion having one to three valences. Examples of such anions include monoanions such as chlorine, bromine, iodine, aryl sulfonates having six to 18 carbon atoms, nitrates, nitrites, and borate anions, dianions such as sulfate and sulfite, and trianions such as phosphate. Alternatively, each X may be a halide anion. Alternatively, each X may chloride (i.e., Cl⁻).

and an organic cationic surfactant c) having one of the following formulas (c-i)-(c-iii):

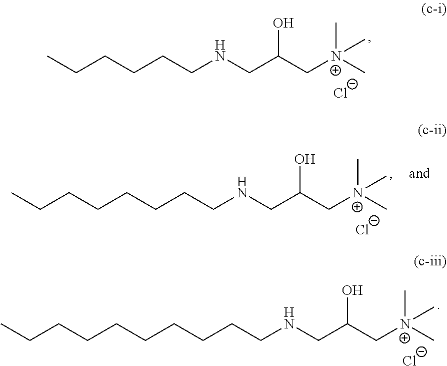

The organic cationic surfactant c) may comprise a combination or two or more different organic cationic surfactants represented by general formula (c-I) above that differ in at least one property such as structure, molecular weight, degree of branching, and number of cationic quaternary ammonium groups Y′ (e.g. when subscript b represents an average value). Organic cationic surfactants may be prepared by the method described in U.S. Provisional Patent Application Ser. No. 62/955,192 filed on 30 Dec. 2019, which is hereby incorporated by reference. The preparation method for the organic cationic surfactant may be as described above for the siloxane cationic surfactant by using an organic amine compound instead of the amino-functional polyorganosiloxane.

The organic cationic surfactant c) is optional and may be utilized in any amount in the foam stabilizing composition, depending on various factors including the form of the composition prepared, a desired use thereof, and other starting materials present therein. For example, one of skill in the art will appreciate that, when the foam stabilizing composition is formulated as a concentrate, the organic cationic surfactant c) will be present in higher relative amounts as compared to non-concentrated forms (e.g. aqueous film-forming foam compositions). As such, the organic cationic surfactant c) may be present in the composition in any amount, such as an amount of from 0.001% to 60%, based on the total weight of the composition. When the organic cationic surfactant c) is present, the composition may comprise the organic cationic surfactant c) in an amount sufficient to provide an end-use composition (i.e., any fully formulated composition comprising the foam stabilizing composition ready for a use) with 0.01% to 1%% of the organic cationic surfactant c), based on the total weight of the end-use composition (i.e., an active amount of organic cationic surfactant c) of 0.01% to 1%). For example, the organic cationic surfactant c) may be utilized in an active amount of 0.05% to 1%, such as 0.1% to 1%, alternatively 0.1% to 0.9%, alternatively 0.1% to 0.7%, alternatively 0.2% to 0.7%, alternatively 0.2% to 0.5%, based on the total weight of the composition, or an end-use composition comprising the same. Alternatively, the organic cationic surfactant c) may be used in an amount sufficient to provide a weight ratio of organic cationic surfactant: colloidal silica (c:a) of 104:1 to 0.1:1 in the composition.

Each of the siloxane cationic surfactant b) and, when present, the organic cationic surfactant c) is independently selected, and thus each variable in formulas (b-I), (b-II), and (c-I), even where representing the same group/moiety and/or having the same definition, is independently selected. However, the siloxane cationic surfactant b) and the organic cationic surfactant c) may be configured in a similar manner with respect to one or more variables in in formulas (b-I), (b-II), and (c-I). For example, each R¹ of the siloxane cationic surfactant b) and the organic cationic surfactant c) may be methyl. Alternatively, each D of the siloxane cationic surfactant b) and the organic cationic surfactant c) may be independently a hydroxypropylene group of one of the following formulas:

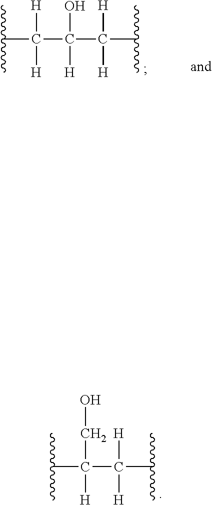 [SMILES: *CC(O)C* ; *CC(*)CO]

Alternatively, each anion X of the siloxane cationic surfactant b) and the organic cationic surfactant c) may be the same. For example, each X of the siloxane cationic surfactant b) and the organic cationic surfactant c) may be a halide anion, alternatively chloride (Cl⁻).

The relative amounts of the siloxane cationic surfactant b) and, when present, the organic cationic surfactant c) utilized in the composition vary, e.g. depending on various factors including the particular siloxane cationic surfactant b) selected, the particular organic cationic surfactant c) selected, and whether another starting material is utilized in the composition.

When the organic cationic surfactant c) is present, the siloxane cationic surfactant b) and the organic cationic surfactant c) may be utilized in a ratio of 10:1 to 1:10, such as 8:1 to 1:8, alternatively 6:1 to 1:6, alternatively 4:1 to 1:4, alternatively 2:1 to 1:2, alternatively 1:1 b):c). For example, the composition may comprise an excess of the organic cationic surfactant c) in relation to the siloxane cationic surfactant b), such that the siloxane cationic surfactant b) and the organic cationic surfactant c) are utilized in a weight ratio (i.e., wt:wt.) of less than 1:1 b):c), such as 1:1.1 to 1:10, alternatively 1:1.5 to 1:10, alternatively 1:2 to 1:10, alternatively 1:3 to 1:10, alternatively 1:4 to 1:10, alternatively 1:5 to 1:10 b):c).

Alternatively, the composition may comprise an excess of siloxane cationic surfactant b) in relation to the organic cationic surfactant c), such that the siloxane cationic surfactant b) and the organic cationic surfactant c) are utilized in a weight ratio (i.e., wt.:wt.) of greater than 1:1 b):c), such as 1.1:1 to 10:1, alternatively 1.5:1 to 10:1, alternatively 2:1 to 10:1, alternatively 2:1 to 8:1, alternatively 2:1 to 6:1, alternatively 2:1 to 5:1 b):c). It will be appreciated, however, that ratios outside of the specific ranges above may also be utilized. For example, one of the siloxane cationic surfactant b) and organic cationic surfactant c) may be utilized in a gross excess of the other (e.g. in an amount of ≥5, alternatively ≥10, alternatively ≥15, alternatively ≥20, times amount of the other).

### Additional Starting Materials

The foam stabilizing composition further comprises water, and may optionally further comprise an additional carrier vehicle (e.g. a solvent, diluent, or dispersant) in addition to the water. When used, the carrier vehicle will be selected depending on various factors such as the species of siloxane cationic surfactant b) and the organic cationic surfactant c), if present, any other starting materials in the composition, and the desired end use of the composition.

Examples of solvents include aqueous solvents, water miscible organic solvents, and combinations thereof. Examples of aqueous solvents include water and polar and/or charged (i.e., ionic) solvents miscible with water. Examples of organic solvents include those comprising an alcohol, such as methanol, ethanol, isopropanol, 1-propanol, 2-propanol, butanol, 2-methyl-2-propanol, and n-propanol; a glycol such as ethylene glycol, propylene glycol, a glycol ether, such as propylene glycol methyl ether, dipropylene glycol methyl ether, propylene glycol n-butyl ether, propylene glycol n-propyl ether, and ethylene glycol n-butyl ether.

Alternatively, the composition may comprise (d-1) a solvent. The solvent (d-1) may facilitate introduction of certain starting materials into the composition, mixing and/or homogenization of the starting materials. Likewise, the particular solvent (d-1) will be selected based on the solubility of starting material b) and/or other starting materials utilized in the composition, the volatility (i.e., vapor pressure) of the solvent, and the end-use of the composition. The solvent may comprise water. The solvent (d-1) should be sufficient to disperse the colloidal silica a), and dissolve or disperse the siloxane cationic surfactant b), and any additional starting materials to form a homogenous composition. As such, solvents for use in the composition may generally be selected from any of the carrier vehicles described above suitable for fluidizing and/or dissolving starting materials a) and b), and/or another starting material of the composition. As will be understood by those of skill in the art, while organic solvents may be utilized in the composition, such organic solvents will typically be removed before utilizing the composition, or an end-use composition comprising the same, especially if the organic solvents are flammable.

Alternatively, the carrier vehicle may be an aqueous solvent, and comprises, alternatively consists essentially of, or alternatively is, water. The water is not particularly limited. For example, purified water such as distilled water and ion exchanged water, saline, a phosphoric acid buffer aqueous solution, or a water containing a base sufficient to render the pH of the water of 7 to 10, alternatively 9 to 10, or combinations thereof, can be used. Alternatively, the carrier vehicle may comprise water and at least one other solvent (i.e., a co-solvent), such as a water-miscible solvent. Examples of such co-solvents may include any of the water miscible carrier vehicles described above. Particular examples of co-solvents include glycerol, sorbitol, ethylene glycol, propylene glycol, hexylene glycol, polyethylene glycol (PEG), ethers of diethylene and dipropylene glycols (e.g. methyl, ethyl, propyl, and butyl ethers), and combinations thereof.

The amount of carrier vehicle utilized is not limited, and depend on various factors, including the type of solvent selected, the amount and type of colloidal silica a), siloxane cationic surfactant b) employed, and the form of the composition (i.e., whether a concentrate, intermediate, or end-use composition). Typically, the amount of carrier vehicle utilized may be 0.1% to 99.9%, based on the total weight of the composition, or the total combined weights of colloidal silica a) and siloxane cationic surfactant b), and carrier vehicle, and when present, organic cationic surfactant c). Alternatively, the carrier vehicle may comprise water, and the composition may comprise a weight ratio of water to colloidal silica (wt:wt) (d:a) of 1:1 to 100:1. Alternatively, the carrier vehicle may be utilized in an amount of 50% to 99.9%, alternatively 60% to 99.9%, alternatively 70% to 99.9%, alternatively 80% to 99.9%, alternatively 90% to 99.9%, alternatively 95% to 99.9%, alternatively 98% to 99.9%, alternatively 98.5% to 99.9%, alternatively 98.5% to 99.7%, alternatively 98.7% to 99.7%, based on the combined weights of the colloidal silica a), the siloxane cationic surfactant b), and the carrier vehicle, and when present the organic cationic surfactant c). One of skill in the art would appreciate that the upper limits of these ranges generally reflect the active amounts of colloidal silica a) and siloxane cationic surfactant b) utilized (i.e., in an end-use composition). As such, amounts outside these ranges may also be utilized.

In the composition, the colloidal silica a), the siloxane cationic surfactant b), and water may be used alone or in combination with at least one additional starting material (such as the organic cationic surfactant c) described above or other additional starting material, described hereinbelow). As such, the composition may further comprise one or more additional starting materials. It is to be appreciated that such starting materials may be classified under different terms of art and just because a starting material is classified under such a term does not mean that it is thusly limited to that function. Moreover, some of these starting materials may be present in a particular component of the composition, or instead may be incorporated when forming the composition. Typically, the composition may comprise any number of starting materials, e.g. depending on the particular type and/or function of the same in the composition.

For example, the composition may comprise one or more starting materials comprising, alternatively consisting essentially of, alternatively consisting of: e) an additional surfactant which differs from the siloxane cationic surfactant b) and the organic cationic surfactant c), described above; f) a rheology modifier; g) a pH control agent; and h) a foam enhancer.

The composition may optionally further comprise the additional surfactant e). The additional surfactant e) is a surfactant other than the cationic surfactants b), and when present c). The additional surfactant e) is not anionic. The additional surfactant e) may comprise one or more cationic, nonionic, and/or amphoteric surfactants, such as any one or more of those described below. In general, the additional surfactant e) is selected to impart, alter, and/or facilitate certain properties of the composition and/or an end-use composition comprising the same, such as compatibility, foamability, foam stability, foam spreading and/or drainage (e.g. vapor sealing/containment). Alternatively, the surfactant e) may be selected from water soluble surfactants.

Alternatively, the additional surfactant e) may comprise, alternatively may be an additional cationic surfactant other than the cationic surfactants b) and c) described above. Examples of such cationic surfactants include various fatty acid amines and amides and their derivatives, and the salts of the fatty acid amines and amides. Examples of aliphatic fatty acid amines include dodecylamine acetate, octadecylamine acetate, and acetates of the amines of tallow fatty acids, homologues of aromatic amines having fatty acids such as dodecylanalin, fatty amides derived from aliphatic diamines such as undecylimidazoline, fatty amides derived from aliphatic diamines such as undecylimidazoline, fatty amides derived from disubstituted amines such as oleylaminodiethylamine, derivatives of ethylene diamine, quaternary ammonium compounds and their salts which are exemplified by tallow trimethyl ammonium chloride, dioctadecyldimethyl ammonium chloride, didodecyldimethyl ammonium chloride, dihexadecyl ammonium chloride, alkyltrimethylammonium hydroxides such as octyltrimethylammonium hydroxide, dodecyltrimethylammonium hydroxide, and hexadecyltrimethylammonium hydroxide, dialkyldimethylammonium hydroxides such as octyldimethylammonium hydroxide, decyldimethylammonium hydroxide, didodecyldimethylammonium hydroxide, dioctadecyldimethylammonium hydroxide, tallow trimethylammonium hydroxide, coconut oil, trimethylammonium hydroxide, methylpolyoxyethylene cocoammonium chloride, and dipalmitoylhydroxyethylammonium methosulfate, amide derivatives of amino alcohols such as beta-hydroxylethylstearylamide, amine salts of long chain fatty acids, and combinations thereof.

Alternatively, the surfactant e) may comprise, alternatively may be, a nonionic surfactant. Examples of nonionic surfactants include polyoxyethylene alkyl ethers (such as, lauryl, cetyl, stearyl or octyl), polyoxyethylene alkylphenol ethers, polyoxyethylene lauryl ethers, polyoxyethylene sorbitan monoleates, polyoxyethylene alkyl esters, polyoxyethylene sorbitan alkyl esters, polyethylene glycol, polypropylene glycol, diethylene glycol, ethoxylated trimethylnonanols, alkyl glucosides, alkyl polyglucosides, polyoxyalkylene glycol modified polysiloxane surfactants, polyoxyalkylene-substituted silicones (rake or ABn types), silicone alkanolamides, silicone esters, silicone glycosides, dimethicone copolyols, fatty acid esters of polyols, for instance sorbitol and glyceryl mono-, di-, tri- and sesqui-oleates and stearates, glyceryl and polyethylene glycol laurates; fatty acid esters of polyethylene glycol (such as polyethylene glycol monostearates and monolaurates), polyoxyethylenated fatty acid esters (such as stearates and oleates) of sorbitol, and combinations thereof. Polyoxyalkylene silicone surfactants are known in the art and are commercially available, e.g., DOWSIL™ 502W and DOWSIL™ 67 Additive are commercially available from Dow Silicones Corporation of Midland, Michigan, USA.

Alternatively, the surfactant e) may comprise, alternatively may be, an amphoteric surfactant. Examples of amphoteric surfactants include amino acid surfactants, betaine acid surfactants, N-alkylamidobetaines and derivatives thereof, proteins and derivatives thereof, glycine derivatives, sultaines, alkyl polyaminocarboxylates and alkylamphoacetates, and combinations thereof. These surfactants may also be obtained from other suppliers under different tradenames.

The additional surfactant e) may be included in the composition in various

concentrations, e.g. depending on the particular form thereof, the particular species selected for the additional surfactant e), the loading/active amounts of colloidal silica a), siloxane cationic surfactant b), and organic cationic surfactant c), if present. However, the additional surfactant e) may be utilized in an amount of 0 to 10 weight parts per 1 weight part of the siloxane cationic surfactant b).

The composition may optionally further comprise the rheology modifier f). The rheology modifier f) is not particularly limited, and is generally selected to alter the viscosity, flow property, and/or a foaming property (i.e., foam-forming ability and/or foam stability) of the composition, or an end-use composition comprising the same. As such, the rheology modifier f) is not particular limited, and may comprise a thickener, stabilizer, viscosity modifier, thixotropic agent, or combinations thereof, which will be generally selected from natural or synthetic thickening compounds. Alternatively, the rheology modifier f) may comprise one or more water soluble and/or water compatible thickening compounds (e.g. water-soluble organic polymers).

Examples of compounds suitable for use in or as the rheology modifier f) include acrylamide copolymers, acrylate copolymers and salts thereof (e.g. sodium polyacrylates, etc.), celluloses (e.g. methylcelluloses, methylhydroxypropylcelluloses, hydroxyethylcelluloses, hydroxypropylcelluloses, polypropylhydroxyethylcelluloses, and carboxymethylcelluloses), starches (e.g. starch and hydroxyethylstarch), polyoxyalkylenes (e.g. PEG, PPG, and PEG/PPG copolymers), carbomers, alginates (e.g. sodium alginate), various gums (e.g. arabic gums, cassia gums, carob gums, scleroglucan gums, xanthan gums, gellan gums, rhamsan gums, karaya gums, carrageenan gums, and guar gums), cocamide derivatives (e.g. cocamidopropyl betaines), medium to long-chain alkyl and/or fatty alcohols (e.g. cetearyl alcohol and stearyl alcohol), gelatin, saccharides (e.g. fructose, glucose, and PEG-120 methyl glucose diolate), and combinations thereof.

Alternatively, the composition may comprise the pH control agent g). The pH control agent g) is not particular limited, and may comprise or be any compound suitable for modifying or adjusting the pH of the composition and/or maintaining (e.g. regulating) the pH of the composition in a particular range. As such, as will be understood by those of skill in the art, the pH control agent g) may comprise, alternatively may be a pH modifier (e.g. an acid and/or a base), a pH buffer, or a combination thereof, such as any one or more of those described below.

Examples of acids generally include mineral acids (e.g. hydrochloric acid, phosphoric acid, and sulfuric acid), organic acids (e.g. citric acid), and combinations thereof. Examples of bases generally include alkali metal hydroxides (e.g. sodium hydroxide and potassium hydroxide), carbonates (e.g. alkali metal carbonate salts such as sodium carbonate), phosphates, and combinations thereof.

In certain embodiments, the pH control agent g) comprises, alternatively is, the pH buffer. Suitable pH buffers are not particularly limited, and may comprise, alternatively may be, any buffering compound capable of adjusting the pH of the composition and/or maintaining (e.g. regulating) the pH of the composition in a particular range. As will be understood by those of skill in the art, examples of suitable buffers and buffering compounds may overlap with certain pH modifiers, including those described above, due to the overlap in functions between the additives. As such, when both are utilized in or as the pH control agent g), the pH buffer and the pH modifier may be independently or collectively selected in view of each other.

In general, suitable pH buffers are selected from buffering compounds that include an acid, a base, or a salt (e.g. comprising the conjugate base/acid of an acid/base). Examples of buffering compounds generally include alkali metal hydroxides (e.g. sodium hydroxide and potassium hydroxide), carbonates (e.g. sesquicarbonates, alkali metal carbonate salts such as sodium carbonate, etc.), borates, silicates, phosphates, imidazoles, citric acid, sodium citrate, and the like, as well as derivatives, modifications, and combinations thereof. Examples of the some pH buffers include citrate buffers, glycerol buffers, borate buffers, phosphate buffers, and combinations thereof (e.g. citric acid-phosphate buffers). As such, some examples of particular buffering compounds suitable for use in or as the pH buffer of the pH control agent g) include ethylenediaminetetraacetic acids (e.g. disodium EDTA), triethanolamines (e.g. tris(2-hydroxyethyl)amine), citrates and other polycarboxylic acid-based compounds, and combinations thereof.

The composition may optionally further comprise the foam enhancer h). Particular compounds/compositions suitable for use in or as the foam enhancer h) are not limited, and generally include those capable of imparting, enhancing, and or modifying a foaming property (e.g. foamability, foam stability, foam drainage, foam spreadability, and/or foam density) of the composition, or an end-use composition comprising the same. As such, one of skill in the art will readily appreciate that compounds/compositions suitable for use in or as the foam enhancer h) may overlap with those described herein with respect to other additives/starting materials of the composition.

For example, in certain embodiments, the foam enhancer h) comprises a stabilizing agent selected from electrolytes (e.g. alkali metal and/or alkaline earth salts of various anions, such as chloride, borate, citrate, and/or sulfate salts of sodium, potassium, calcium, and/or magnesium, and aluminum chlorohydrates), polyelectrolytes (e.g. hyaluronic acid salts, such as sodium hyaluronates), polyols (e.g. glycerine, propylene glycols, butylene glycols, and sorbitols), hydrocolloids, and combinations thereof.

Alternatively, the foam enhancer h) may comprise a saccharide compound, i.e., a compound comprising at least one saccharide moiety. It is to be appreciated that the term “saccharide” may be used synonymously with the term “carbohydrate” under general circumstances, and terms like “sugar” under more specific circumstances. As such, the nomenclature of any particular saccharide is not exclusionary with regard to suitable saccharide compounds for use in or as the foam enhancer h). Rather, as will be understood by those of skill in the art, suitable saccharide compounds may include, alternatively may be, any compound comprising a moiety that can be described as a saccharide, carbohydrate, sugar, starch, cellulose, or a combination thereof. Likewise, any combination of more than one saccharide moiety in the saccharide compounds may be described in more descriptive terms. For example, the term “polysaccharide” may be used synonymously with the term “glycoside,” where both terms generally refer to a combination of more than one saccharide moiety (e.g. where the combination of saccharide moieties are linked together via a glycosidic linkage and collectively form a glycoside moiety). One of skill in the art will appreciate that terms such as “starch” and “cellulose” may be used to refer to such combinations of saccharide moieties under specific circumstances (e.g. when a combination of more than one saccharide moiety in the saccharide compound conforms to the structure known in the art as a “starch” or a “cellulose”).

Examples of saccharide compounds suitable for use in or as the foam enhancer h) may include compounds, or compounds comprising at least one moiety, conventionally referred to as a monosaccharide and/or sugar (e.g. pentoses (i.e., furanoses), such as riboses, xyloses, arabinoses, lyxoses, fructoses, and hexoses (i.e., pyranoses), such as glucoses, galactoses, mannoses, guloses, idoses, taloses, alloses, and altroses), a disaccharide (e.g. sucroses, lactoses, maltoses, and trehaloses), an oligosaccharide (e.g. malto-oligosaccharides, such as maltodextrins, arafinoses, stachyoses, and fructooligosaccharides), a polysaccharide (e.g. celluloses, hemicelluloses, pectins, glycogens, hydrocolloids, starches such as amyloses, and amylopectins), or a combination thereof.

Other examples of foam enhancers suitable for use in or as the foam enhancer h) are known in the art. For example, the foam enhancer h) may comprise a polymeric stabilizer, such as those comprising a polyacrylic acid salt, a modified starch, a partially hydrolyzed protein, a polyethyleneimine, a polyvinyl resin, a polyvinyl alcohol, a polyacrylamides, a carboxyvinyl polymer, a fatty acid such as myristic acid or palmitic, or combinations thereof. Alternatively, the foam enhancer h) may comprise a thickener, such as those comprising one or more gums (e.g. xanthan gum), collagen, galactomannans, starches, starch derivatives and/or hydrolysates, cellulose derivatives (e.g. methyl cellulose, hydroxypropylcellulose, hydroxyethyl cellulose, and hydroxypropyl methyl cellulose), polyvinyl alcohols, vinylpyrrolidone-vinylacetate-copolymers, polyethylene glycols, polypropylene glycols, or a combination thereof.

The composition may comprise one or more additional components/additives, i.e., other than those described above, which are known in the art and will be selected based on the particular starting materials utilized in the composition and a desired end-use thereof. For example, the composition may comprise: a filler (other than colloidal silica a)); a filler treating agent; a surface modifier; a binder; a compatibilizer; a colorant (e.g. a pigment or dye); an anti-aging additive; a flame retardant; a corrosion inhibitor; a UV absorber; an anti-oxidant; a light-stabilizer; a heat stabilizer; and combinations thereof. However, the composition described above may be free of perfluoroalkyl surfactants. Alternatively, the composition may be free of perfluoroalkyl substances. Furthermore, the composition may be free of anionic surfactants.

### Method of Making the Composition

The composition may be prepared by combining starting materials comprising the colloidal silica a) and the siloxane cationic surfactant b), as well as any optional starting materials (e.g. c)-h) described above), in any order of addition, optionally with a master batch, and optionally under mixing.

Alternatively, the composition may be prepared by pre-mixing the siloxane cationic surfactant b) with an optional starting material to prepare an intermediate composition that is subsequently combined with the colloidal silica a) to prepare the composition. Alternatively, the composition may be prepared by pre-mixing the colloidal silica a) with an optional starting material to prepare an intermediate composition that is subsequently combined with the siloxane cationic surfactant b) to prepare the composition. For example, the siloxane cationic surfactant b) may be combined with the pH control agent to prepare a siloxane cationic surfactant composition, which is subsequently combined with the colloidal silica a) to prepare the composition. Alternatively, the pH control agent is a mineral acid (e.g. HCl) and utilized in an amount sufficient to protonate some, but not all, amine groups of the siloxane cationic surfactant b), thereby preparing the siloxane cationic surfactant composition as a buffer solution. Alternatively, when the organic cationic surfactant c) is used, c) may be combined with the pH control agent to prepare an organic cationic surfactant composition, which is subsequently combined with the colloidal sillica a) and the siloxane cationic surfactant b) (e.g. independently or in the form of the siloxane cationic surfactant composition) to prepare the composition. The pH control agent may be a mineral acid (e.g. HCl) utilized in an amount sufficient to protonate some, but not all, amine groups of the organic cationic surfactant c), thereby preparing the organic cationic surfactant composition as a buffer solution. One of skill in the art will appreciate that the pH control agent may comprise multiple functions, such as to adjust the pH of one or more individual starting materials of the composition, to buffer one or more intermediate compositions, and/or to modify, control, and/or buffer the pH of the composition by itself or in combination with one or more other starting materials.

The foam stabilizing composition may be prepared as a concentrate, e.g. via combining the colloidal silica a) and the siloxane cationic surfactant b), optionally together with any of starting materials c) to h), but with minimal or no amount of water. If solvent is used to facilitate mixing and/or dispersion of starting materials a) and b), then all or a portion of the solvent may be removed to prepare the concentrate. Alternatively, the composition may comprise water in an amount of 1 weight part to 100 weight parts of water, per 1 weight part of colloidal silica a).

The foam stabilizing composition may be formulated as a foam-forming composition (e.g. via diluting a concentrate of the composition, as described above, with a starting material comprising water, which may be as described above as a carrier vehicle or alternatively have an alternative source, e.g., sea water) or utilized as an additive to prepare a foam-forming composition (e.g. via combining the foam stabilizing composition with a base formulation, i.e., a formulation comprising foaming agents, solvents/carriers, additives, or a combination thereof). For example, the foam-forming composition can be prepared by providing water (e.g. as an active flow from a hose or pipe or in a reaction vessel/reactor), optionally combined with one or more foam additives, and combining the foam stabilizing composition with the water (e.g. as a pre-formed mixture, via addition individual starting materials a), b), and when present one or more of c) to h)). In either of such instances, the foam-forming composition comprising the foam stabilizing composition, once prepared, may be aerated or otherwise expanded (e.g. via foaming equipment or application to an aerated water stream/flow) to form a foam composition (i.e., a “foam”).

The foam prepared with the foam stabilizing composition is suitable for use in various applications. For example, as introduced above, the composition may be utilized in firefighting applications, e.g., extinguishing, suppressing, and/or preventing fire. In particular, due to the increased stability provided by the composition, foams prepared therewith may be used for extinguishing fires involving chemicals with low boiling points, high vapor pressures, and/or limited aqueous solubility (e.g. gasoline and/or organic solvents), which are typically extremely flammable and/or difficult to extinguish and/or prevent reignition. For example, such a fire may be extinguished by contacting the fire with foam (e.g. by spraying the foam onto the fire or spraying the foam-forming composition over the fire to prepare the foam thereon). In similar fashion, the foam may be utilized to secure chemicals (e.g. from a spill or leak thereof) to limit vapor leak and/or ignition, by the applying the foam to the top of the spill/leak, or otherwise forming the foam thereon.

Alternatively, the foams may be produced by mechanically agitating or submitting to other conventional foam-producing methods an aqueous mixture having the same composition as the final foam. Alternatively, a foam concentrate is produced with starting materials listed from a) to h) above which is diluted with adequate amount of water (e.g., sea water) and agitated to produce an aqueous foam with the desired quality. Alternatively, the colloidal silica a) (e.g., in powder form or as an aqueous dispersion) may be separately mixed with a concentrate of the siloxane cationic surfactant b) and optionally one or more of starting materials d) to h) described above, and thereafter diluted with an adequate amount of water and agitated to produce an aqueous foam with the desired quality. Without wishing to be bound by theory, it is thought that it may be beneficial to store the concentrate of the colloidal silica a) separately from the concentrate containing the siloxane cationic surfactant b), and to mix the separate concentrates at the point of application to maximize shelf-life of the foam-forming composition. The finished foam may then be dispensed upon a polar fuel and/or a hydrocarbon fuel fire.

### EXAMPLES

These examples are intended to illustrate the invention to one skilled in the art and are not to be construed to limit the scope of the invention set forth in the claims. Starting materials used in these examples are summarized below.

TABLE 1
Starting Materials

| Name | Label | Description |
|---|---|---|
| Nalco 1142 | C1 | Colloidal silica with particle size 15 nm from Ecolab |
| Nalco 1115 | C2 | Colloidal silica with particle size 4 nm from Ecolab |
| Nalco 2329 | C3 | Colloidal silica with particle size 75 nm from Ecolab |
| Si4PrN-QUAB | S1 | Cationic silicone surfactants prepared according to Reference |
| | | Example 1 |
| Si4PrPDA-(QUAB)2 | S2 | Cationic silicone surfactants prepared according to Reference |
| | | Example 2 |
| Si10PrPDA-QUAB | S3 | Cationic silicone surfactants prepared according to Reference |
| | | Example 3 |
| Si10PrPDA-(QUAB)2 | S4 | Cationic silicone surfactants prepared according to Reference |
| | | Example 4 |
| 4 DP QUAB terminated | S5 | Cationic silicone surfactants prepared according to Reference |
| siloxane | | Example 5 |
| 4 DP QUAB(2) | S6 | Cationic silicone surfactants prepared according to Reference |
| terminated siloxane | | Example 6 |
| 15 DP QUAB terminated | S7 | Cationic silicone surfactants prepared according to Reference |
| siloxane | | Example 7 |
| 15 DP QUAB(2) | S8 | Cationic silicone surfactants prepared according to Reference |
| terminated siloxane | | Example 8 |
| N,N-diethyl-4-(3- | S9 | Cationic silicone surfactants prepared according to Reference |
| (1,1,1,3,5,5,5- | | Example 9 |
| heptamethyltrisiloxan-3- | | |
| yl)propoxy)-2-hydroxy- | | |
| N-methylbutan-1- | | |
| aminium iodide | | |
| C6N-QUAB | CoS1 | Cationic aliphatic (organic) surfactant prepared according to |
| | | Reference Example 10 |
| Cetrimonium chloride | CoS2 | Cetyltrimethylammonium chloride from TCI America |
| (CTAC) | | |
| Hexylamine of formula | CoS3 | Cationic aliphatic (organic) agent from Sigma Aldrich |
| (CH₃)(CH₂)5NH₂ | | |
| DOWSIL ™ 502W | CoS4 | Nonionic surfactant comprising poly(oxy-1,2-ethanediyl), |
| | | .alpha.-[3-[1,3,3,3-tetramethyl-1- |
| | | [(trimethylsilyl)oxy\|disiloxanyl]propyl]-.omega.-hydroxy with |
| | | CAS no. 67674-67-3 and polyethylene oxide monoallyl ether |
| | | with CAS no. 27274-31-3 from Dow Silicones Corporation |
| pH Control Agent | | 2N hydrochloric acid (HCl) |
| Si₁₀PrPDA | | Amine dendrimer prepared as described in reference example |
| | | 3, below. |

CTAC had formula:

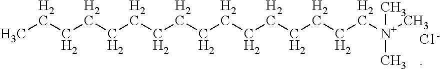 [SMILES: CCCCCCCCCCCCCCCC[N+](C)(C)C]

In this Reference Example 1, Si4PIN-QUAB of formula:

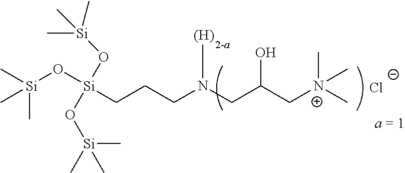

was prepared as follows: 3-aminopropyltris(trimethylsiloxy)silane (95.41 g), glycidyltrimethylammonium chloride (61.2 g; 72.7% solution in water), ethanol (89.35 g), and HCl (0.58 g; 2N) are mixed in a 3-neck round bottom flask stirred and heated to 65° C. The reaction was held at temperature for ˜2.5 hours. The solution was allowed to cool to <40° C. and then HCl (46.22 g; 2N) was added and mixed. Then D¹ water (107.6 g) was added to the reaction solution and mixed for ˜3 hours. The final product was 34.94% surfactant, 42.74% water, and 22.32% ethanol.

In this Reference Example 2, Si₄PrPDA-(QUAB)₂ of formula:

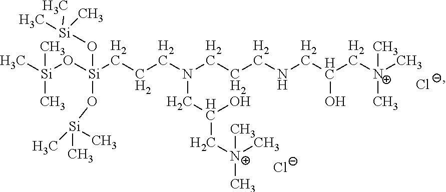

was prepared as follows: 3-(propyl)propane-1,3-diaminetris(trimethylsiloxy)silane (3.34 g), glycidyltrimethylammonium chloride (3.69 g, 2.0 eq.; 72.7% solution in water), and ethanol (3.23 g) are added and mixed in a 2 oz sample vial. The reaction solution was heated to 60° C. and held at temperature for ˜10 hours. The sample was then cooled to room temperature. The final product structure was confirmed by ¹H NMR and the concentration of the solution was 58.69% surfactant, 9.83% water, and 31.48% ethanol.

In this Reference Example 3, Si₁₀PrPDA-(QUAB) of formula:

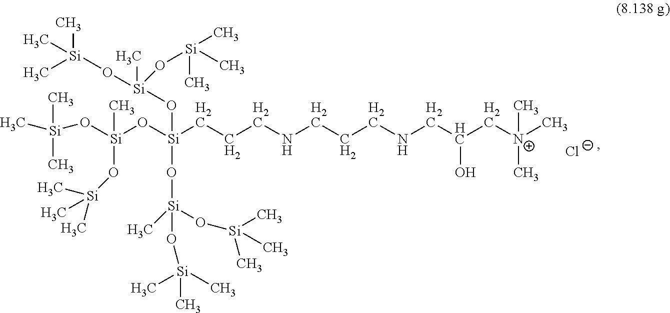

was prepared as follows: Si₁₀PrPDA of formula

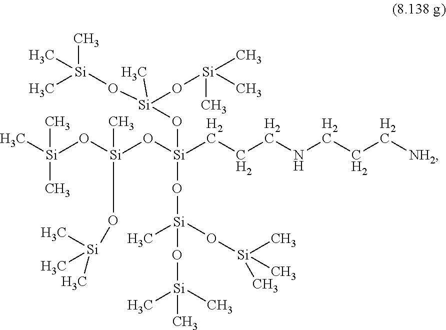 [SMILES: C[Si](C)(C)O[Si](C)(O[Si](C)(C)C)O[Si](CCCNCCCN)(O[Si](C)(O[Si](C)(C)C)O[Si](C)(C)C)O[Si](C)(O[Si](C)(C)C)O[Si](C)(C)C]

glycidyltrimethylammonium chloride (2.54 g, 0.58 eq.; 72.7% solution in water), and ethanol (4.54 g) are added and mixed in a 2 oz sample vial. The reaction solution was heated to 60° C. and held at temperature for ˜4 hours. The sample was then cooled to room temperature. The final product structure was confirmed by ¹H NMR and the concentration of the solution was 65.69% surfactant, 4.53% water, and 29.78% ethanol.

The Si₁₀PrPDA was prepared as follows:

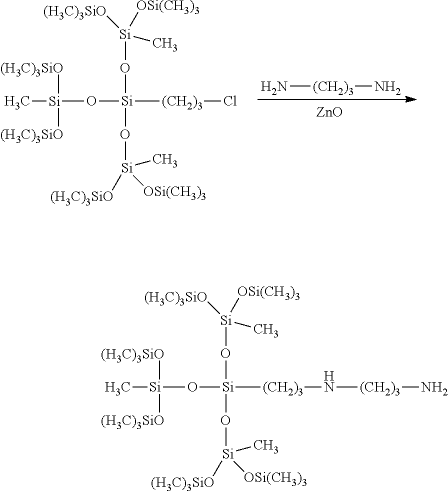

A 200 mL receiving flask is charged with Si10PrCl (50 g), 1,3-diaminopropane (25 g), and ZnO (2.62 g), and then heated to and held at 140° C. for 9 hours using an oil bath. The mixture is then cooled to room temperature, filtered to remove solids, and phase separated. The top layer is collected and concentrated with a rotary evaporator (120° C.; <1 mmHg; 60 minutes) to give the product (Si10PDA; nearly colorless).

In this Reference Example 4, Si₁₀PrPDA-(QUAB)₂ of formula:

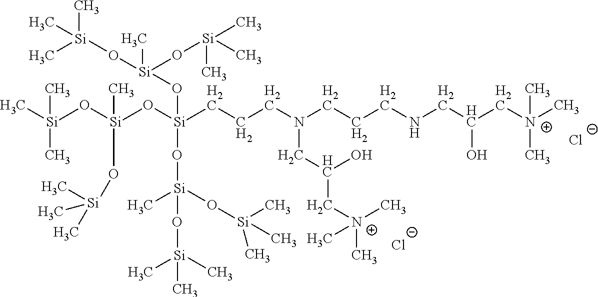

was prepared as follows: SinoPrPDA (6.846 g, prepared as described above), glycidyltrimethylammonium chloride (3.68 g, 1.08 eq.; 72.7% solution in water), and ethanol (4.54 g) were added and mixed in a 2 oz sample vial. The reaction solution was heated to 60° C. and held at temperature for ˜4.5 hours. The sample was then cooled to room temperature. The final product structure was confirmed by ¹H NMR and the concentration of the solution was 63.23% surfactant, 6.64% water, and 30.13% ethanol.

In this Reference Example 5, a cationic terminate Dp 4 siloxane of formula:

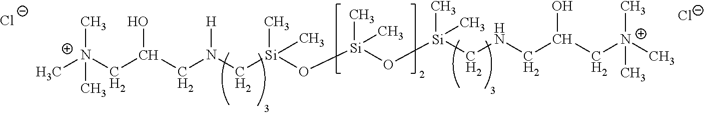

was prepared as follows: dimethyl, propylamine terminate siloxane (3.64 g), glycidyltrimethylammonium chloride (3.86 g, 1.08 eq.; 72.7% solution in water), and ethanol (4.03 g) were added and mixed in a 2 oz sample vial. The reaction solution was heated to 60° C. and held at temperature for ˜2 hours. The sample was then cooled to room temperature. At room temperature there was a small amount of white solids in the solution. The reaction solution was filtered through a 5 μm syringe filter and collected. The final product structure was confirmed by ¹H NMR and the concentration of the solution was 55.94% surfactant, 9.11% water, and 34.95% ethanol.

In this Reference Example 6, a cationic terminate Dp 4 siloxane of formula:

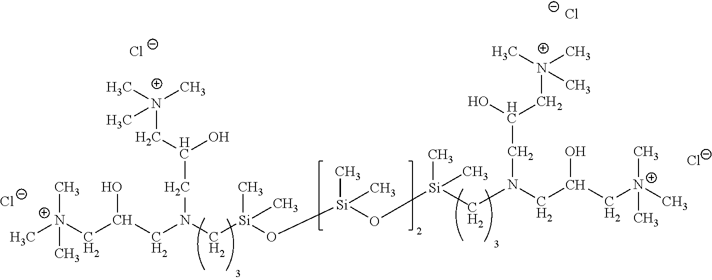

was prepared as follows: dimethyl, propylamine terminate siloxane (2.42 g), glycidyltrimethylammonium chloride (5.00 g, 1.08 eq.; 72.7% solution in water), and ethanol (4.01 g) were added and mixed in a 2 oz sample vial. The reaction solution was heated to 60° C. and held at temperature for ˜7 hours. The sample was then cooled to room temperature. At room temperature there was a small amount of white solids in the solution. The reaction solution was filtered through a 5 μm syringe filter and collected. The final product structure was confirmed by ¹H NMR and the concentration of the solution was 52.97% surfactant, 11.95% water, and 35.08% ethanol.

In this Reference Example 7, a cationic terminated Dp 15 siloxane of formula:

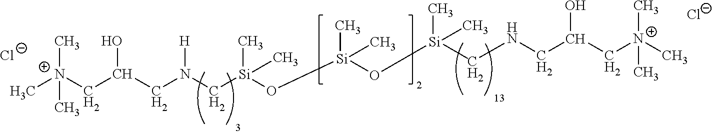

was prepared as follows: dimethyl, propylamine terminate siloxane (3.98 g), glycidyltrimethylammonium chloride (1.06 g, 1.08 eq.; 72.7% solution in water), and ethanol (5.05 g) were added and mixed in a 2 oz sample vial. The reaction solution was heated to 60° C. and held at temperature for ˜2.5 hours. The sample was then cooled to room temperature. At room temperature there was a small amount of white solids in the solution. The reaction solution was filtered through a 5 μm syringe filter and collected. The final product structure was confirmed by ¹H NMR and the concentration of the solution was 47.07% surfactant, 2.87% water, and 50.06% ethanol.

In this Reference Example 8, a cationic terminated Dp 15 siloxane of formula:

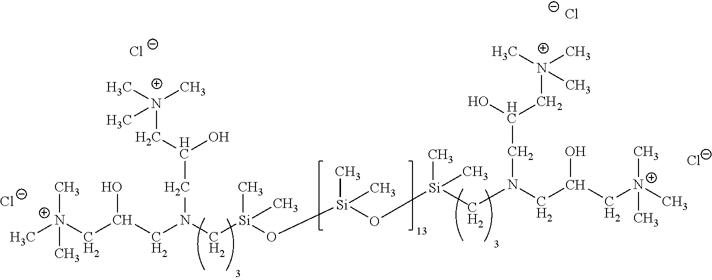

was prepared as follows: dimethyl, propylamine terminate siloxane (3.98 g), glycidyltrimethylammonium chloride (1.06 g, 1.08 eq.; 72.7% solution in water), and ethanol (5.05 g) were added and mixed in a 2 oz sample vial. The reaction solution was heated to 60° C. and held at temperature for ˜2.5 hours. The sample was then cooled to room temperature. At room temperature there was a small amount of white solids in the solution. The reaction solution was filtered through a 5 μm syringe filter and collected. The final product structure was confirmed by ¹H NMR and the concentration of the solution was 47.07% surfactant, 2.87% water, and 50.06% ethanol.

In this Reference Example 9, a cationic trisiloxane of formula:

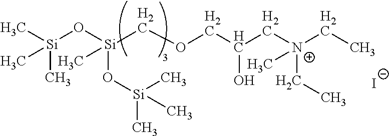

was prepared as follows: The synthesis of the cationic trisiloxane was a three step reaction. The first reaction was a hydrosilylation where 1,1,1,3,5,5,5-heptamethyltrisiloxane (62.22 g) and allyl glycidyl ether (3.74 g) was heated in a 3-neck round bottom flask to 75° C. Once at temperature, a solution in IPA of 1% Pt from Karstedt's catalyst was added. The remaining allyl glycidyl ether (47.60 g) was metered into the reaction solution, maintaining the reaction temperature at <90° C. The excess allyl glycidyl ether was removed via vacuum distillation. The resulting epoxy functional trisiloxane (7.93 g), diethylamine (5.17 g), and isopropyl alcohol (3.65 g) were added to a 2 oz sample vial, mixed and heated to 75° C. The reaction mixture was held at temperature for ˜2 hours, and then the IPA and excess diethylamine was removed using a rotary evaporator and vacuum pump. The resulting tertiary amine functional trisiloxane (7.10 g) and methyl iodine (3.12 g) were added to a 2 oz sample vial and mixed at room temperature. The reaction solution turned brown and the viscosity of the sample increased. The sample was mixed for ˜30 minutes at room temperature. The excess methyl iodine was then removed using a rotary evaporator and vacuum pump. Ethanol (2.02 g) was added to the remaining high viscosity brown solution to decrease the viscosity and produce the cationic trisiloxane solution, which was 79.8% cationic trisiloxane surfactant and 20.2% ethanol.

In this Reference Example 10: C6-QUAB of formula

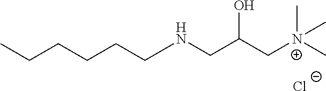

was prepared as follows: 1-hexylamine (2.82 g), glycidyltrimethylammonium chloride (6.21 g; 72.7% solution in water), ethanol (5.02 g), and HCl (1.35 g; 0.1N) were mixed in a 1 oz vial and stirred on a 60° C. heating block to give a mixture, which turned clear within ˜2 minutes. The mixture was stirred for 2.5 hours, then pH Control Agent (4.69 g) was added, and the solution stirred at RT for 1 hour to give a composition comprising a cationic surfactant (C6-QUAB; 36.7% concentration).

In this Reference Example 11, of C8-QUAB of formula

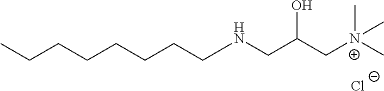

was prepared as follows: 1-octylamine (3.60 g), glycidyltrimethylammonium chloride (6.21 g; 72.7% solution in water), ethanol (5.04 g), and HCl (1.35 g; 0.1N) were mixed in a 1 oz vial and stirred on a 60° C. heating block to give a mixture, which turned clear within ˜3 minutes. The mixture was stirred for 2.5 hours, then pH Control Agent (4.76 g) was added and the solution stirred at RT for 1 hour to give a composition comprising a cationic surfactant (C8-QUAB; 38.6 wt. % concentration).

In this Reference Example 12, C10-QUAB of formula

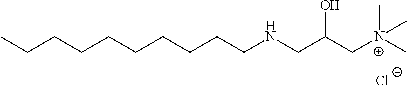 [SMILES: CCCCCCCCCCNCC(O)C[N+](C)(C)C ; [Cl-]]

was prepared as follows: 1-decylamine (4.38 g), glycidyltrimethylammonium chloride (6.19 g; 72.7% solution in water), ethanol (5.00 g), and HCl (1.35 g; 0.1N) are mixed in a 1 oz vial and stirred on a 60° C. heating block to give a mixture, which turns clear within ˜4 minutes. The mixture is stirred for 2.5 hours, then pH Control Agent (4.72 g) is added and the solution stirred at RT for 1 hour to give a composition comprising a cationic surfactant (C10-QUAB; 40.8 wt. % concentration).

In this Reference Example 13, firefighting foam samples were prepared as follows. The starting materials were combined in the amounts (weight parts) in Table 2 and homogenized using an IKA Ultra Turrex homogenizer to make foams. The homogenizer was operated at 6000 RPM and 100 ml of the foam formulation was sheared for 5 minutes to generate sufficient foam for a single experiment. For measurement on hot heptane and isopropanol, a flat-bottom crystallizing dish with a diameter of 100 mm and height of 50 mm was used. A digital camera (Canon Rebel T3i) with an 18-55 mm lens was used to capture images of the foams from the side of the container at fixed time intervals to visualize the dynamics of foam collapse. The light source, focus, aperture, and shutter speed were adjusted manually according to needs.

TABLE 2
Foam Formulations prepared according to the procedure in Reference Example 13

| Starting | Weight (g) | | | | | | | | | |
|---|---|---|---|---|---|---|---|---|---|---|
| Material Label | IE1 | IE2 | IE3 | IE4 | IE5 | IE6 | IE7 | IE8 | IE9 | IE10 |
| C1 | 12.54 | 12.49 | 12.48 | 12.48 | | 12.49 | 97.54 | | 12.6 | 12.51 |
| C2 | | | | | 13.35 | | | | | |
| C3 | | | | | | | | 12.66 | | |
| S1 | 0.3 | | | | 0.3 | 0.44 | 0.3 | 0.3 | | |
| S2 | | 0.17 | | | | | | | | |
| S3 | | | 0.15 | | | | | | | |
| S4 | | | | 0.16 | | | | | | |
| S5 | | | | | | | | | | 0.46 |
| S6 | | | | | | | | | | |
| S7 | | | | | | | | | | |
| S8 | | | | | | | | | | |
| S9 | | | | | | | | | 0.27 | |
| CoS1 | 0.39 | 0.38 | 0.39 | 0.39 | 0.39 | | 0.39 | 0.41 | | |
| CoS2 | | | | | | | | | | |
| CoS3 | | | | | | | | | | |
| CoS4 | | | | | | | | | | |
| Water | 86.82 | 87.36 | 86.94 | 86.96 | 85.98 | 87.06 | 1.85 | 86.79 | 87.25 | 87.07 |
| R | 0.055 | 0.053 | 0.054 | 0.054 | 0.137 | 0.031 | 0.007 | 0.056 | 0.043 | 0.051 |

| Starting | Weight (g) | | | | | | | | |
|---|---|---|---|---|---|---|---|---|---|
| Material Label | IE11 | IE12 | IE13 | CE1 | CE2 | CE3 | CE4 | CE5 | CE6 |
| C1 | 12.49 | 12.49 | 24.99 | | 13.2 | 12.46 | 12.49 | 2.49 | 0.27 |
| C2 | | | | | | | | | |
| C3 | | | | | | | | | |
| S1 | | | 0.44 | 0.86 | | | | 2.87 | 2.85 |
| S2 | | | | | | | | | |
| S3 | | | | | | | | | |
| S4 | | | | | | | | | |
| S5 | | | | | | | | | |
| S6 | | 0.47 | | | | | | | |
| S7 | | | | | | | | | |
| S8 | 0.44 | | | | | | | | |
| S9 | | | | | | | | | |
| CoS1 | | | | 1.16 | | | | 0.41 | 0.39 |
| CoS2 | | | | | | 1.74 | | | |
| CoS3 | | | | | 0.67 | | | | |
| CoS4 | | | 0.06 | | | | 0.49 | | |
| Water | 87.12 | 87.07 | 74.53 | 98.04 | 86.83 | 85.76 | 87 | 94.25 | 96.51 |
| R | 0.051 | 0.049 | 0.021 | NA | 0.127 | 0.349 | 0.098 | 1.187 | 10.8 |

Where R is the ratio of all surfactants in the formulation to colloidal silica.

In this Reference Example 14 the foams prepared as described above were evaluated. For measurement with heptane at 60° C., 40 ml of heptane was poured into a dish. The dish was heated on a hot plate to allow heptane to reach 60° C. and maintained at that temperature. Then a 2 cm thick layer of foam was dispensed on top of the hot heptane and the hot plate was subsequently switched off. Image series was recorded at 1 frame every 2 seconds. The recorded images were imported in ImageJ image analysis software. “Line tool” in ImageJ was used to calculate the foam height in each image of the image series. Foam height at time=0 (first image) was subtracted from the heights measured in subsequent images to calculate the % change in foam height as a function of time.

The foam was observed from the top and side. Foam was declared completely collapsed when a hole was observed in the foam blanket which exposed the fuel underneath. This procedure was repeated using 40 ml of isopropanol at 35° C. in the dish. Results are shown below in Tables 3, 4, and 5

TABLE 3
Foam Evaluation Foam stability on 60° C. heptane (Time for a foam to decrease in height by 100%)

| Tested Property | IE1 | IE2 | IE3 | IE4 | IE5 | IE6 | IE7 | IE8 | IE9 | IE10 |
|---|---|---|---|---|---|---|---|---|---|---|
| Foam Stability | >20 | >20 | >20 | >20 | >20 | >20 | >20 | >20 | >20 | >20 |
| on 60° C. | minutes | minutes | minutes | minutes | minutes | minutes | minutes | minutes | minutes | minutes |
| Heptane | | | | | | | | | | |

TABLE 4
Foam Evaluation on Heptane (continued)

| Tested Property | IE11 | IE12 | IE13 | CE1 | CE2 | CE3 | CE4 | CE5 | CE6 |
|---|---|---|---|---|---|---|---|---|---|
| Foam Stability | >20 | >20 | 18 min | 4 min | 14 min | 1 min | 52 sec | 1 min | 1 min |
| on 60° C. | minutes | minutes | 44 sec | 20 sec | 40 sec | 14 sec | | 8 sec | 32 sec |
| Heptane | | | | | | | | | |

TABLE 5
Foam stability on 35° C. isopropanol (IPA)

| Tested Property | IE1 | IE2 | IE3 | IE4 | IE5 | IE6 | IE9 | CE1 | CE2 | CE3 | CE4 | CE5 | CE6 |
|---|---|---|---|---|---|---|---|---|---|---|---|---|---|
| Foam Stability | >20 | >20 | >20 | >20 | >20 | >20 | >20 | 0 sec | 0 sec | 0 sec | 0 sec | 0 sec | 0 sec |
| on 35° C. | minutes | minutes | minutes | minutes | minutes | minutes | minutes | | | | | | |
| IPA | | | | | | | | | | | | | |

The foam of the Inventive Examples (IE) had superior stability (>15 min on both 60° C. heptane and 35° C. IPA) to all of the Comparative Examples (CE). Inventive Example 1 had superior stability on 60° C. heptane compared to all the Comparative Examples. Moreover, none of the Comparative Example foams showed any stability over isopropanol under the conditions tested; each collapsed immediately. However, the foam of Inventive Example 1 was stable for more than 20 minutes over isopropanol tested under the same conditions.

Comparative Example 1 did not contain starting material a), colloidal silica. Comparative Examples 2, 3, and 4 did not contain starting material b), the siloxane cationic surfactant described herein. Comparative Examples 2 and 3) did not contain any siloxane. Comparative Example 2 was prepared in accordance with Ultrastable Particle-Stabilized Foams, Gonzenbach et. al., Angew. Chem. Intl. Ed., 2006, 45, 3526-3530. Comparative Example 3 was prepared in accordance with GB1175760. Comparative Example 4 contained a nonionic organosilicon compound. Comparative Example 4 was prepared in accordance with U.S. Pat. No. 3,655,554. Comparative Examples 1, 2, 3, and 4 all had extremely poor stability on IPA (a polar alcohol fuel) under the conditions tested. Comparative Examples 1, 3, and 4 also had poor stability on heptane (a nonpolar fuel).

The examples above showed that a foam with superior stability on both heptane and IPA could be prepared as described herein, suggesting that the foam prepared from the composition described herein can have superior stability on polar (e.g., alcohol containing) fuels such as methanol, IPA, and/or ethanol compared to previous compositions as well as superior stability on nonpolar (e.g. hydrocarbons such as heptane) fuels. The foam also showed superior stability free standing (compared to the foams made without colloidal silica).

Problems to be Addressed: There is an industry need for a firefighting foam that is water dilutable, and PFAS (perfluoroalkyl substance)-free. The firefighting foam prepared should be able to spread over surfaces of different fuels, including both a flammable oil and a solvent. The firefighting foam should be stable over a hot fuel surface and able to extinguish a flammable liquid (class B) fire. The firefighting foam should be able to prevent the fuel from reigniting after extinction.

Solution: A firefighting foam prepared from the composition described herein may be able to both extinguish fires on hot fuel surfaces and prevent reignition under the conditions tested. Without wishing to be bound by theory, it is thought that the combination of the siloxane cationic surfactant with the colloidal silica particles in water creates a robust aqueous foam blanket on top of the fuel surface, effectively suppressing the fuel vapors from coming in contact with oxygen to form a combustible mixture. Consequently, rapid heat knockdown, quick fire extinction and superior resistance to reignition was achieved without the use of perfluorinated surfactants.

The firefighting foam prepared from the composition, as described herein, may have superior stability on surfaces of hot fuels including gasoline, jet fuel, and/or heptane as well as good stability on alcohol containing polar fuels such as methanol, ethanol, and/or isopropanol. In addition the firefighting foam prepared as described herein may show superior free standing capability. The firefighting foam prepared as described herein may have slow liquid drainage and good water retention, compared to foams generated from other surfactant used with no colloidal silica. The firefighting foam described herein may have good fire extinction performance.

### Definitions and Usage of Terms

All amounts, concentrations, ratios, and percentages are by weight unless otherwise indicated. The amounts of all starting materials in a composition total 100% by weight. The SUMMARY and ABSTRACT are hereby incorporated by reference. The articles ‘a’, ‘an’, and ‘the’ each refer to one or more, unless otherwise indicated. The singular includes the plural unless otherwise indicated. Abbreviations are defined below in Table 6.

TABLE 6
Abbreviations

| Abbreviation | Definition |
|---|---|
| AFFF | aqueous film forming foam |
| BCF | tris(pentafluorophenyl)borane |
| ° C. | degrees Celsius |
| CTAC | cetrimonium chloride |
| DI | deionized |
| g | gram |
| ¹H NMR | Proton nuclear magnetic resonance tested as described |
| | below |
| IPA | isopropanol |
| mL or ml | milliliter |
| mm | millimeter |
| mmHg | millimeter of mercury |
| nm | nanometer |
| oz | ounce |
| PFAS | perfluoroalkyl substances |
| ppm | parts per million |
| RPM | revolutions per minute |
| RT | Room temperature of 23° C. ± 2° C. |

The ¹H NMR analysis method used to analyze the synthesized examples is as follows: The 1H NMR samples were prepared for analysis by adding the desired compound to a sample vial and diluting it ˜10× in a deuterated NMR solvent such as deuterated chloroform or deuterium oxide. The solution was then mixed with a vortex mixer and pipetted into a 5 mm NMR tube. The 1H NMR samples were analyzed on an Agilent 400-MR NMR spectrometer at 400 MHz, equipped with a 5 mm OneNMR probe. The 1H NMR data analysis was performed using MNova from Mestrelab Research (Version 12.0.4-22023).

1. A foam stabilizing composition, comprising:
a) colloidal silica having a particle size of 1 nm to 100 nm;
b) a siloxane cationic surfactant selected from the group consisting of
general formula (b-I): [Z¹-D¹-N(Y)ₐ(R)₂₋ₐ]^{+y} [X^{-x}]ₙ,
general formula (b-II): 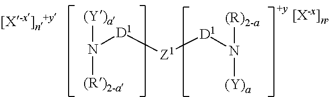
and
a combination of both (b-I) and (b-II); where
Z¹ is a siloxane moiety;
D¹ is a divalent linking group;
each R and each R′ is independently selected from the group consisting of H or an unsubstituted hydrocarbyl group having from 1 to 4 carbon atoms;
each Y and each Y′ has formula -D-NR¹₃+, where
D is a divalent linking group, and
each R¹ is independently an unsubstituted hydrocarbyl group
having from 1 to 4 carbon atoms;
subscript a is 1 or 2;
subscript a′ is 1 or 2;
1≤y≤3;
1≤y′3;
X and X′ are each an independently selected anion;
subscript n is 1, 2, or 3;
1≤x≤3;
with the proviso that (x*n)=y;
subscript n′ is 1, 2, or 3;
1≤x′≤3; and
with the proviso that (x′*n′)=y′;
optionally c) an organic cationic surfactant having general formula (c-I): [Z²-D²-N(Y)_{b}(R)_{2-b}]^{+u} [X^{-x}]ₙ,
where Z² is an unsubstituted hydrocarbyl group;
D² is a covalent bond or a divalent linking group;
subscript b is 1 or 2; and
each R, Y, superscript y, X, subscript n, and superscript x is independently selected and as defined above; and
d) water; where
the colloidal silica is present in a weight ratio of 1:10⁻⁴ to 1:1 with respect to the siloxane cationic surfactant and, when present, the organic cationic surfactant; and
the water is present in a weight ratio of 1:1 to 100:1 with respect to the colloidal silica.

2. The foam stabilizing composition of claim 1, where in the siloxane cationic surfactant of general formula (b-I), the siloxane moiety Z¹ has the formula: 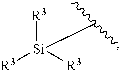
where each R³ is independently selected from R² and —OSi(R⁴)₃, with the proviso that at least one R³ is —OSi(R⁴)₃; where each R⁴ is independently selected from R², —OSi(R⁵)₃, and —[OSiR²₂]ₘOSiR²₃; where each R⁵ is independently selected from R², —OSi(R⁶)₃, and —[OSiR²₂]ₘOSiR²₃; where each R⁶ is independently selected from R² and —[OSiR²₂]ₘOSiR²₃; where 0≤m≤100; and where each R² is independently a substituted or unsubstituted hydrocarbyl group.

3. The foam stabilizing composition of claim 2, where the siloxane moiety Z¹ has one of the following structures (i)-(iv):

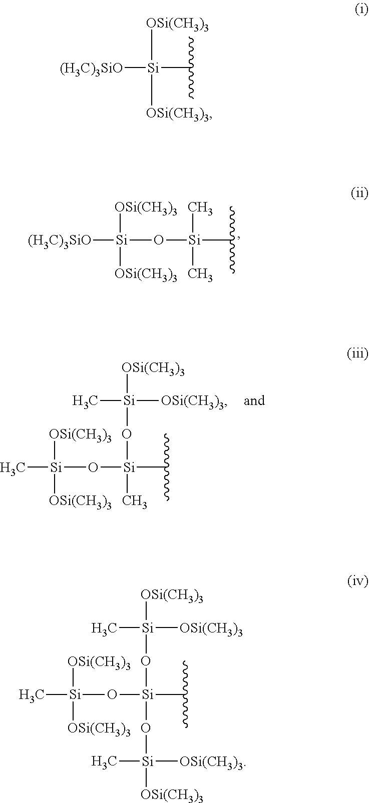

4. The foam stabilizing composition of any one of claims 1-3, where: (i) D¹ is a branched or linear alkylene group; or (ii) D¹ has formula -D³-N(R⁷)-D³-, where each D³ is an independently selected divalent linking group and R⁷ is H or Y, where Y is independently selected and as defined above.

5. The foam stabilizing composition of any one of claims 1-4, where in the siloxane cationic surfactant (A): (i) subscript a is 1; (ii) superscript y is 1; (iii) R is H; or (iv) any combination of (i)-(iii).

6. The foam stabilizing composition of any one of claims 1-5, where: (i) each D¹ is selected from —CH₂CH(OH)CH₂— and —HC(CH₂OH)CH₂—; (ii) each R¹ is methyl; (iii) each X is Cl and superscript x is 1; or (iv) any combination of (i)-(iii).

7. The foam stabilizing composition of any one of claims 1-3, where in the siloxane cationic surfactant b) of general formula (b-II), the siloxane moiety Z¹ has the formula (R²₂SiO_{2/2})_{DP}, where each R² is an independently selected alkyl group and subscript DP is 2 to 15.

8. The foam stabilizing composition of any one of claims 1-7, where the weight ratio of colloidal silica with respect to the siloxane cationic surfactant and, when present, the organic cationic surfactant, is 1:10⁻⁴ to 1:0.1.

9. The foam stabilizing composition of any one of claims 1-8, where the colloidal silica has a particle size of 2 nm to 20 nm.

10. The foam stabilizing composition of any one of claims 1-9, where c) the organic cationic surfactant is present, and in general formula (c-I), Z² is an alkyl group having from 6 to 18 carbon atoms; and where D² is selected from the group consisting of: i) the covalent bond; ii) a branched or linear alkylene group; and iii) a group of formula -D⁴-N(R⁸)-D⁴-, where each D⁴ is an independently selected divalent linking group and R⁸ is H or Y, where Y is independently selected and as defined above.

11. The foam stabilizing composition of claim 10, where in general formula (c-I): (i) subscript b is 1; (ii) superscript y is 1; (iii) R is H; or (iv) any combination of (i)-(iii).

12. The foam stabilizing composition of any one of claims 1-11, comprising a weight ratio of c) the organic cationic surfactant to a) the colloidal silica of 10⁻⁴:1 to 0.1:1 (c:a).

13. The foam stabilizing composition of any one of claims 1-12, further comprising at least one additive selected from: d) a carrier vehicle other than water; e) an additional surfactant other than the siloxane cationic surfactant b) and the organic cationic surfactant c); f) a rheology modifier; g) a pH control agent; and h) a foam enhancer.

14. A firefighting foam comprising the foam stabilizing composition of any one of claims 1-13 and water with a pH of 7-10.

15. A method of extinguishing a fire comprising contacting the fire with the firefighting foam of claim 14.

16. A siloxane cationic surfactant of formula: 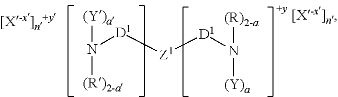
where
Z¹ is a divalent siloxane moiety;
each D¹ is an independently selected divalent linking group;
R and R′ are each independently selected from H and an unsubstituted hydrocarbyl group having from 1 to 4 carbon atoms;
each Y and each Y′ has formula -D-NR¹₃+, where
D is a divalent linking group; and
each R¹ is independently an unsubstituted hydrocarbyl group having from 1 to 4 carbon atoms; subscript a is 1 or 2;
1≤y≤3;
subscript a′ is 1 or 2;
1≤y′≤3;
X and X′ are each an independently selected anion;
subscript n is 1, 2, or 3;
1≤x≤3,
with the proviso that (x*n)=y;
subscript n′ is 1, 2, or 3;
1≤x′≤3,
with the proviso that (x′*n′)=y′.

17. The siloxane cationic surfactant of claim 16, where each X is a halide.

18. The siloxane cationic surfactant of claim 16 or claim 17, where Z¹ has formula: 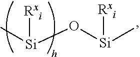
where each subscript i is independently selected from 0, 1, or 2; subscript h≥1, and each R^{x} is independently selected from hydrocarbyl groups, alkoxy and/or aryloxy groups, and siloxy groups.

19. The siloxane cationic surfactant of claim 18, where Z¹ is linear and has formula: 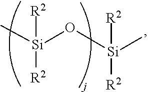
where each R² is an independently selected alkyl group of 1 to 10 carbon atoms, and subscript j is 2 to 15.

20. The siloxane cationic surfactant of any one of claims 16 to 19, where each D¹ is a divalent hydrocarbyl group of formula —(CH₂)_{d}—, where subscript d is 1 to 18.

21. The siloxane cationic surfactant of any one of claims 16 to 20, where each D is a hydroxyl-substituted hydrocarbon having formula -D′-CH(—(CH₂)ₑ—OH)-D′-, where each D′ is independently a covalent bond or an independently selected alkylene group having 1 to 8 carbon atoms, and subscript e is 0 or 1.

22. The siloxane cationic surfactant of any one of claims 16 to 21, where the siloxane cationic surfactant has a formula selected from the group consisting of (b-II-i) to (b-II-iv), where formualas of (b-II-i) to (b-II-iv) are:

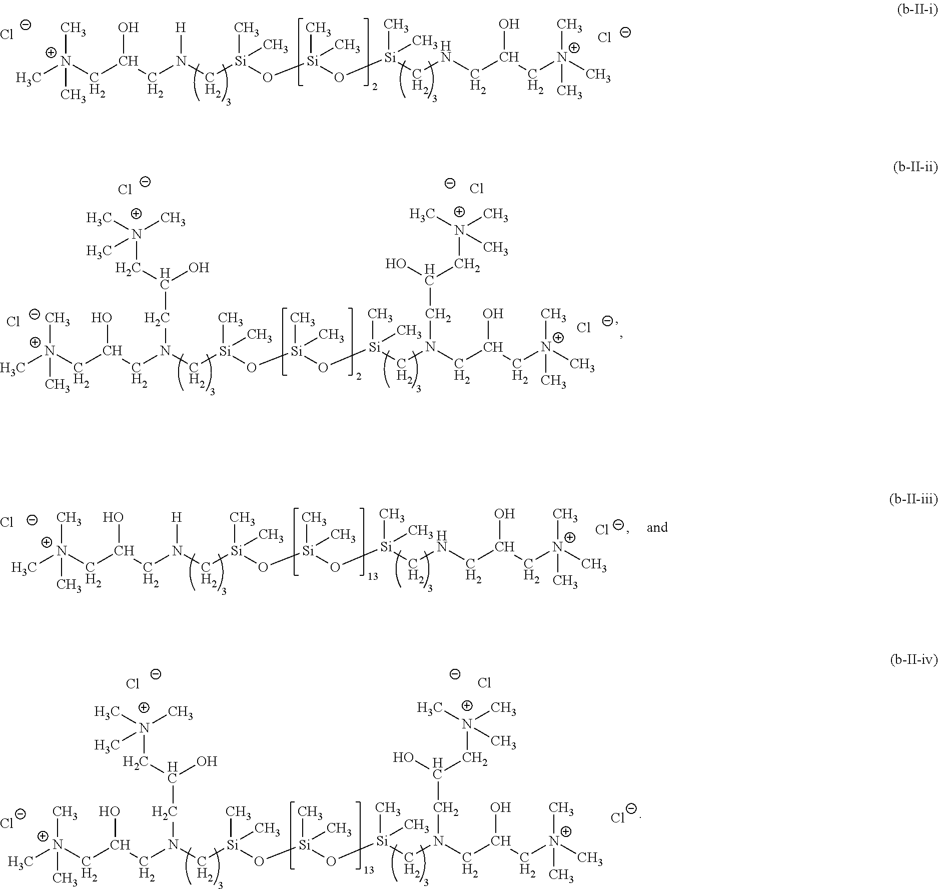

23. A method for preparing the siloxane cationic surfactant of any one of claims 16 to 22, where the method comprises:
reacting (a) an amino-functional polyorganosiloxane and (b) a quaternary ammonium compound to give the siloxane cationic surfactant; where
(a) the amino-functional polyorganosiloxane comprises formula: Z¹(-D⁴-NHR)a, where
Z¹ is the siloxane moiety described above,
D⁴ is a covalent bond or an unsubstituted divalent hydrocarbon group,
R is H or an unsubstituted hydrocarbyl group having from 1 to 4 carbon atoms, and subscript a is 1 or more, depending on the functionality of Z¹; and
(b) the quaternary ammonium compound has formula: [R⁸NR¹₃]⁺[X]⁻, where
R⁸ is an amine-reactive group;
each R¹ is the independently selected unsubstituted hydrocarbyl group having from 1 to 4 carbon atoms; and
X is an anion.

24. The method of claim 23, where: (i) R⁸ is an epoxyalkyl group; (ii) each R¹ is alkyl; (iii) each X is halide; or (iv) any combination of (i) to (iii).
